(19) United States
(12) Patent Application Publication
(10) Pub. No.: US 2026/0112344 A1
(43) Pub. Date: Apr. 23, 2026

(54) GRAPHICAL USER INTERFACE FOR GENERATIVE ADVERSARIAL NETWORK MUSIC SYNTHESIZER

(71) Applicant: Sony Group Corporation, Tokyo (JP)

(72) Inventors: Gaku NARITA, Tokyo (JP); Junichi SHIMIZU, Tokyo (JP); Taketo AKAMA, Tokyo (JP); Shintaro OGUCHI, Tokyo (JP); Kohei YAMAMOTO, Tokyo (JP); Haruhiko KISHI, Tokyo (JP)

(73) Assignee: Sony Group Corporation, Tokyo (JP)

(21) Appl. No.: 19/117,414

(22) PCT Filed: Sep. 7, 2023
(86) PCT No.: PCT/JP2023/032711

§ 371 Date: Apr. 1, 2025

(30) Foreign Application Priority Data
Oct. 13, 2022 (JP) 2022-164477

(51) Int. Cl. G10H 1/00

(52) U.S. Cl. CPC G10H 1/0025; G10H 2210/056; G10H 2210/111; G10H 2210/325; G10H 2220/116; G10H 2250/235; G10H 2250/311

(57) ABSTRACT

An information processing system that receives input sound and pitch information; extracts a timbre feature amount from the input sound; and generates information of a musical instrument sound with a pitch based on the timbre feature amount and the pitch information.

### CROSS REFERENCE TO RELATED APPLICATIONS

This application claims the benefit of Japanese Priority Patent Application JP 2022-164477 filed on Oct. 13, 2022, the entire contents of which are incorporated herein by reference.

### TECHNICAL FIELD

The technology disclosed in the present specification (hereinafter, “the present disclosure”) relates to an information processing apparatus and an information processing method, a computer program, a sound generation system, and an information terminal that perform information processing related to music production.

### BACKGROUND ART

Development of artificial intelligence (AI) technology is remarkable, and recognition technology for images, voices, and the like using a learning model has become widespread. Recently, image generation techniques have also been developed that use Generative Adversarial Networks (GAN) to generate sophisticated images. Moreover, a method of utilizing AI technology for music production is also being sought. For example, a musical sound emphasizing device that emphasizes a sound source using a deep neural network (DNN) reflecting features of a musical instrument sound (see PTL 1), an information processing method that automatically generates various pieces of music using a learned model generated using GANs or a variational auto encoder (VAE) (see PTL 2), and the like have been proposed.

### CITATION LIST

### Patent Literature

PTL 1: JP 2019-78864A
PTL 2: JP 2020-3535A

### Non Patent Literature

NPL 1: Arantxa Casanova, Marl'ene Careil, Jakob Verbeek, Michal Drozdzal, and Adriana Romero-Soriano, “Instance-conditioned GAN”, in Advances in Neural Information Processing Systems (NeurIPS), 2021.
NPL 2: Jesse Engel, Cinjon Resnick, Adam Roberts, Sander Dieleman, Mohammad Norouzi, Douglas Eck, and Karen Simonyan, “Neural audio synthesis of musical notes with wavenet autoencoders”, in International Conference on Machine Learning. PMLR, 2017, pp. 1068-1077.
NPL 3: Aaron van den Oord, Sander Dieleman, Heiga Zen, Karen Simonyan, Oriol Vinyals, Alex Graves, Nal Kalchbrenner, Andrew Senior, and Koray Kavukcuoglu, “Wavenet: A generative model for raw audio”, arXiv preprint arXiv: 1609. 03499, 2016.
NPL 4: Jesse Engel, Kumar Krishna Agrawal, Shuo Chen, Ishaan Gulrajani, Chris Donahue, and Adam Roberts, “Gansynth: Adversarial neural audio synthesis”, in International Conference on Learning Representations, 2018.
NPL 5: Sean Vasquez and Mike Lewis, “Melnet: A generative model for audio in the frequency domain”, arXiv preprint arXiv: 1906. 01083, 2019.

### SUMMARY

### Technical Problem

Two approaches for producing music using a computer are mainly a method of directly synthesizing a sound of music including a melody and an accompaniment, and a method of synthesizing a monophonic musical instrument sound and playing a musical instrument digital interface (MIDI). In the former, although music can be generated end-to-end, there is a problem that the controllability of generation is low. On the other hand, the latter has an advantage that the generation of MIDI and the design of the timbre can be independently controlled, and the quality of the generated sound is high.

Therefore, the present disclosure provides an information processing apparatus and an information processing method, a computer program, a sound generation system, and an information terminal that perform information processing related to generation of a musical instrument sound usable for MIDI playing, for example.

### Solution to Problem

The present disclosure has been made in view of the above problems, and a first aspect thereof is an information processing system including: circuitry configured to receive input sound and pitch information; extract a timbre feature amount from the input sound; and generate information of a musical instrument sound with a pitch based on the timbre feature amount and the pitch information.

The circuitry uses a learned model to generate information of a musical instrument sound.

The circuitry uses the learned model to generate information of the musical instrument sound with the pitch using information after preprocessing the input sound and pitch information as instance conditions.

Furthermore, the circuitry is configured to extract the timbre feature amount of the input sound so that no pitch information remains.

Furthermore, the circuitry is configured to extract the timbre feature using a timbre feature extractor that has performed adversarial learning regarding a pitch.

Another aspect of the disclosure is directed to an information processing method comprising: receiving input sound and pitch information; extracting a timbre feature amount from the input sound; and generating information of a musical instrument sound with a pitch based on the timbre feature amount and pitch information

Another aspect of the disclosure is directed to one or more non-transitory computer readable medium, which, when executed by circuitry, cause the circuitry to: receive input sound and pitch information; extract a timbre feature amount from the input sound; and generate information of a musical instrument sound with a pitch based on the timbre feature amount and pitch information

The computer program may be obtained by defining a computer program described in a computer-readable format so as to implement predetermined processing on a computer. The computer program can be provided to a computer capable of executing various programs or codes by a storage medium provided in a computer-readable format, a communication medium, for example, a storage medium such as an optical disk, a magnetic disk, a semiconductor memory, or the like, or a communication medium such as a network or the like. Then, by installing the computer program according to the third aspect of the present disclosure in a computer via any medium, a cooperative action is exerted on the computer, and similar operation and effect to those of the information processing apparatus according to the first aspect of the present disclosure can be obtained.

Furthermore, another aspect of the disclosure is directed to a sound generation system comprising: a terminal configured to requests generation of a musical instrument sound; and an information processing apparatus that generates a musical instrument sound, wherein the information terminal is configured to receive input sound and pitch information; extract a timbre feature amount from the input sound; and generate the information of a musical instrument sound with a pitch based on the timbre feature amount and the pitch information.

However, a “system” described here refers to a logical assembly of a plurality of apparatuses (or functional modules that implement specific functions), and each of the apparatuses or functional modules may be or may be not in a single housing. That is, one device including a plurality of components or functional modules and an assembly of a plurality of devices correspond to the “system”.

Furthermore, another aspect of the disclosure is directed to an information terminal comprising: a communication interface configured to communicate with an information processing system; and a user interface configured to receive a designation related to generation of a musical instrument sound including an input sound and pitch information, wherein the communication interface is configured to transmit a request for generating the musical instrument sound including the input sound and pitch information to the information processing system, and receive, from the information processing system, information of the musical instrument sound.

### Advantageous Effects of Invention

According to the present disclosure, it is possible to provide an information processing apparatus and an information processing method, a computer program, a sound generation system, and an information terminal that perform information processing of generating a musical instrument sound with a pitch reflecting a feature of an arbitrary input sound.

Note that the effects described in the present specification are merely examples, and the effects to be brought by the present disclosure are not limited thereto. Further, in addition to the above effects, the present disclosure might further exhibit additional effects in some cases.

Other objects, characteristics, and advantages of the present disclosure will become apparent from a more detailed description based on embodiments described below and the accompanying drawings.

### BRIEF DESCRIPTION OF DRAWINGS

FIG. 1 is a diagram illustrating an outline of the present disclosure.

FIG. 2 is a diagram illustrating a mechanism for generating a musical instrument sound on the basis of inspiration obtained by mixing two input sounds.

FIG. 3 is a diagram illustrating a functional configuration of a musical instrument sound generation system 300 that generates a musical instrument sound with a pitch reflecting a characteristic of an input sound.

FIG. 4 is a flowchart illustrating a processing procedure for generating a musical instrument sound with a pitch reflecting a characteristic of an input sound.

FIG. 5 is a diagram illustrating an example of a workflow at the time of learning of a timbre feature extractor.

FIG. 6 is a diagram illustrating a workflow at the time of learning of a timbre feature extractor in a case where adversarial learning regarding a pitch is performed.

FIG. 7 is a diagram illustrating an outline of a model in a case where a generator used in a generation unit 303 of the musical instrument sound generation system 300 is learned.

FIG. 8 is a diagram illustrating a processing flow of reconstructing audio waveform data from a mel spectrogram.

FIG. 9 is a diagram illustrating a frequency scale conversion processing flow by an iterative method of repeating update by a gradient method and correction to a non-negative value.

FIG. 10 is a diagram illustrating a frequency scale conversion processing flow by an iterative method in a case where an initial value utilizing a solution of a least squares method without a non-negative value constraint is set.

FIG. 11 is a diagram illustrating a configuration of a musical instrument sound generation system 300 including a client server model 1100.

FIG. 12 is a diagram illustrating an exemplary processing sequence performed by a client 1102 and a server 1101.

FIG. 13 is a diagram illustrating a configuration example of a GUI screen for generating and reproducing a musical instrument sound with a pitch according to an embodiment of the present disclosure.

FIG. 14 is a diagram illustrating an operation example on the GUI screen illustrated in FIG. 13.

FIG. 15 is a diagram illustrating an operation example on the GUI screen illustrated in FIG. 13.

FIG. 16 is a diagram illustrating an operation example on the GUI screen illustrated in FIG. 13.

FIG. 17 is a diagram illustrating an operation example on the GUI screen illustrated in FIG. 13.

FIG. 18 is a diagram illustrating an operation example on the GUI screen illustrated in FIG. 13.

FIG. 19 is a diagram illustrating an operation example on the GUI screen illustrated in FIG. 13.

FIG. 20 is a diagram illustrating an operation example on the GUI screen illustrated in FIG. 13.

FIG. 21 is a diagram illustrating an operation example on the GUI screen illustrated in FIG. 13.

FIG. 22 is a diagram illustrating an operation example on the GUI screen illustrated in FIG. 13.

FIG. 23 is a diagram illustrating an operation example on the GUI screen illustrated in FIG. 13.

FIG. 24 is a diagram illustrating another configuration example of the GUI screen for generating and reproducing a musical instrument sound with a pitch according to an embodiment of the present disclosure.

FIG. 25 is a diagram illustrating a modification of the GUI screen illustrated in

FIG. 24.

FIG. 26 is a diagram illustrating a specific hardware configuration example of an information processing apparatus 2000.

FIG. 27 is a diagram illustrating an outline of a model of IC-GAN.

### DESCRIPTION OF EMBODIMENTS

In the description below, the present disclosure will be explained in the following order, with reference to the drawings.
A. Overview
B. Sound generation system
B-1. System configuration
B-2. System operation
B-3. System Features
B-4. System Operation
C. Extraction of timbre feature amount
D. Generation of musical instrument sound with pitch reflecting characteristics of input sound
E. Reconstruction of audio waveform
F. Operational form by client server model
G. Configuration and operation example of GUI
G-1. First example
G-2. Second example
H. Configuration of information processing apparatus
I. Comparison with related studies

### A. Overview

The present disclosure is a technique for generating a monophonic musical instrument sound. Music production on a computer is realized by a method of playing MIDI using a musical instrument sound generated on the basis of an embodiment of the present disclosure. According to the music production method using an embodiment of the present disclosure, it is possible to independently control generation of MIDI and design of timbre, and there is an advantage that quality of generated sound is improved.

The present disclosure is a technique for generating a monophonic musical instrument sound, but it is possible to generate the musical instrument sound on the basis of, for example, inspiration obtained from an arbitrary input sound generated in a living space of a human. In addition, the musical instrument sound generated by the present disclosure is not limited to the musical instrument sound generated using a real musical instrument. That is, a musical instrument sound produced by the present disclosure is a sound that is less likely to be discriminated as a musical instrument but is not discriminated as a sound produced by the musical instrument, in other words, a sound that is not discriminated as a sound produced by a sound other than the musical instrument.

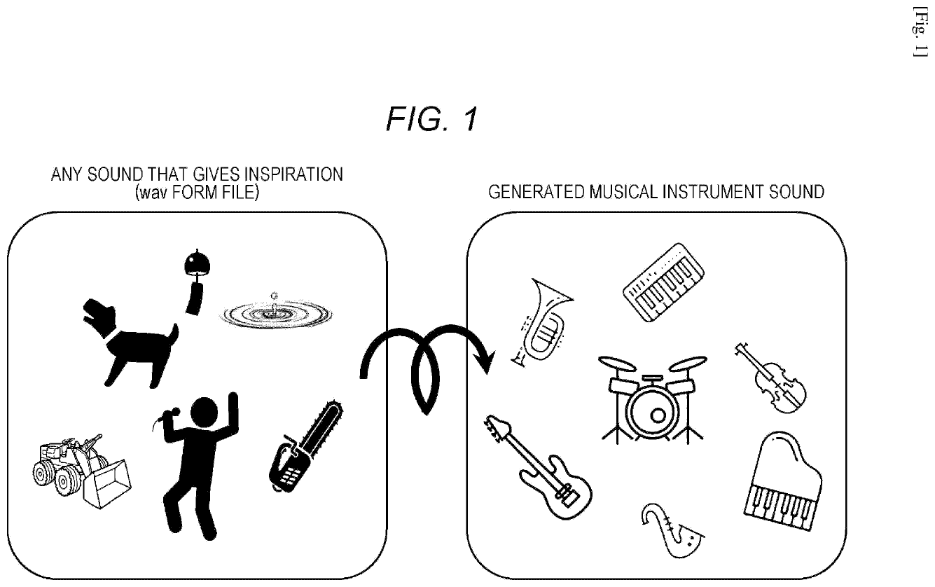

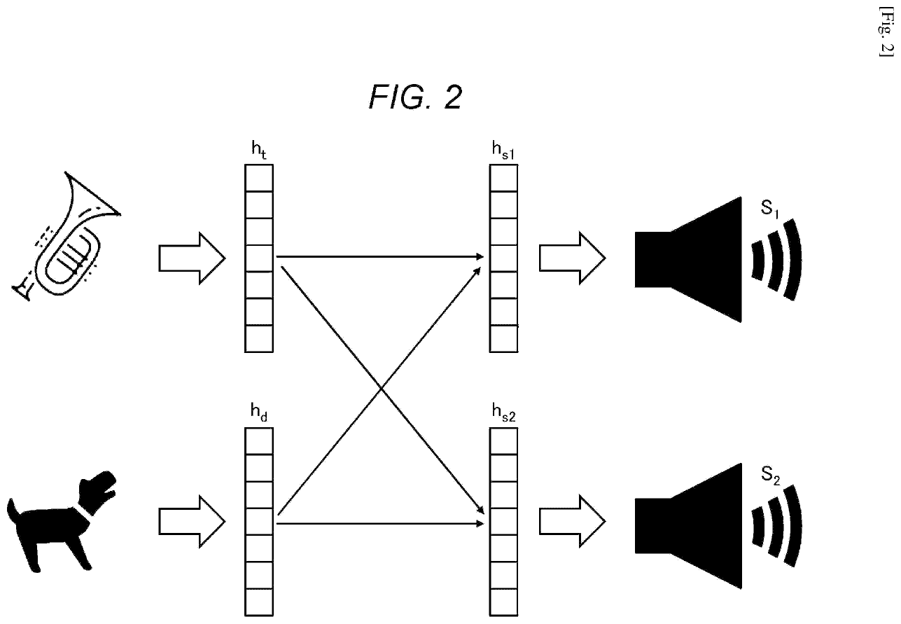

FIG. 1 schematically illustrates an outline of the present disclosure. In the present disclosure, any input sound that gives inspiration is, for example, various sounds generated in a living environment of a human, and includes not only natural sounds and environmental sounds but also artificial sounds artificially generated in advance. For example, the noise may be a sound of conversation, a singing voice of karaoke, a cry of an animal such as a dog or a bird, an environmental sound such as a deer peek or a rain sound, a wind bell sound, or a wind sound, or a noise that cuts or pulverizes an object with a chain saw, a heavy machine, or the like. These optional input sounds are input as audio files such as way format files for convenience of computer processing.

Then, in the present disclosure, a musical instrument sound is generated on the basis of the inspiration obtained from the input sound. Specifically, according to the present disclosure, a monophonic musical instrument sound having a specified pitch for a relatively short time of about one second or several seconds is output as MIDI data, for example. The musical instrument sound generated by the present disclosure may be a single sound produced by an existing musical instrument such as a keyboard instrument, a percussion instrument, a string instrument, a wind instrument, or an electric or electronic instrument, but is not limited thereto, and a completely new and unique musical instrument sound can be produced. Unique musical instrument sounds produced by the present disclosure are sounds that is not likely to be discriminated as musical instruments, but are not discriminated as sounds produced by the musical instruments, in other words, sounds produced by other instruments.

In the present disclosure, a musical instrument sound is generated as conditions of an input sound and a pitch using a deep-learned generation model. Therefore, according to the present disclosure, there are effects that the user can freely customize the musical instrument and that the music can be associated with sound. The deep-learned generation model referred to herein is a learned model unique to the present disclosure, and specifically, is a generator generated by a framework (hereinafter, also referred to as “present disclosure model”) of a GAN that generates musical instrument sounds using an idea of an instance conditional GAN (IC-GAN).

In the past, as a method of synthesizing musical instrument sounds, there are methods such as a “synthesizer” that modulates an artificially generated periodic oscillator waveform to control a timbre, and a “sampling” that records and processes an actual musical instrument sound in order to express realism of an acoustic musical instrument that is difficult to synthesize by the synthesizer. Sampling can directly utilize any sound for music production, but cannot generate a completely new timbre or combine characteristics of a plurality of sounds.

On the other hand, according to the present disclosure, it is possible to search a latent space, generate a wide variety of completely new and unique musical instrument sounds, and perform intelligent sound synthesis processing of combining characteristics of a plurality of sounds by using a deep-learned generation model. Furthermore, according to the present disclosure, it is possible to create completely new and unique musical instrument sounds by mixing two or three or more arbitrary input sounds in a latent representation of a deep-learned generation model.

FIG. 2 schematically illustrates, as an example, a mechanism for generating a musical instrument sound on the basis of inspiration obtained by mixing two input sounds according to the present disclosure. In the example illustrated in FIG. 2, the audio waveform of the trumpet as a first input sound and the audio waveform of the dog barking as a second input sound are captured as files of way format. First, each input sound is subjected to a timbre feature extractor to obtain feature vectors hₜ and h_{d}, respectively. Next, each feature vector is synthesized at a mixing ratio specified by a user or the like. Then, a unique musical instrument sound based on the inspirations obtained from the first input sound and the second input sound is generated. Specifically, a learned model (generator) generated by the present disclosure model generates a unique musical instrument sound on the condition of the feature vector of the synthesized timbre and the pitch specified by the user.

The user can control the musical instrument sound made by adjusting the mixing ratio of the plurality of input sounds. In the example illustrated in the upper part of FIG. 2, the feature vectors hₜ and h_{d} of the first input sound and the second input sound are mixed at a ratio of 0.5:0.5 to generate a combined feature vector hₛ₁. Then, a unique musical instrument sound S₁ resembling a trumpet with the timbre of a dog is generated from the feature vector hₛ₁ by using the deep-learned generation model. Furthermore, in the example illustrated in the lower part of FIG. 2, the feature vectors hₜ and h_{d} of the first input sound and the second input sound are mixed at a ratio of 0.8:0.2 to generate a combined feature vector hₛ₂. Then, a unique musical instrument sound S₂ similar to a dog barking with a timbre of the trumpet is generated using the deep-learned generation model.

The generation technology of a musical instrument sound using the deep-learned generation model according to the present disclosure has the following characteristics (1) to (4).
(1) Inspiration of arbitrary sound of a user can be input to a generation model like a sampler, and is efficiently generalized to various input sounds.
(2) It is possible to mix a plurality of sounds via the latent space by using the deep-learned generation model.
(3) A wide range of pitches can be generated with accurate and consistent timbre.
(4) It is possible to generate musical instrument sounds within an interactive time.

In the present disclosure, a generation model generated by using IC-GAN is applied from the viewpoint of enabling input to a model and improving generalization characteristics for the input. The IC-GAN expresses the distribution of the entire data as the superposition of the local distribution in the vicinity of the instance by conditioning the generator and the discriminator with the feature amount of the data point, that is, the instance. The IC-GAN is a new technology of learning of the GAN that can realize input to the model and avoidance of mode collapse.

### B. Sound Generation System

### B-1. System Configuration

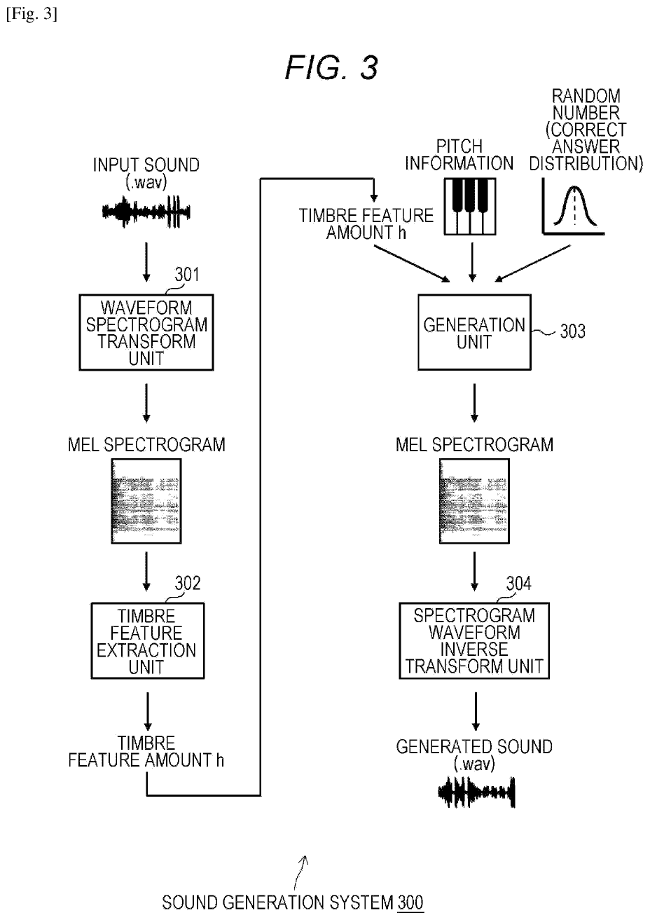

FIG. 3 schematically illustrates a functional configuration of a musical instrument sound generation system 300 that generates a musical instrument sound with a pitch reflecting a characteristic of an input sound on the basis of the present disclosure.

Referring to FIG. 3, the musical instrument sound generation system 300 includes a waveform spectrogram transform unit 301, a timbre feature extraction unit 302, a generation unit 303, and a spectrogram waveform inverse transform unit 304. Among them, the timbre feature extraction unit 302 and the generation unit 303 are implemented using DNN. The musical instrument sound generation system 300 receives an input sound including a short-time audio waveform (way file), a pitch, and a random number, and outputs a musical instrument sound with a pitch reflecting a feature of the input sound. The output musical instrument sound has a length of about one second or several seconds.

The musical instrument sound generation system 300 receives an input sound including an audio waveform as a way format file. The spectrogram transform unit 301 generates a linear spectrogram of the input sound by short-time Fourier transform, and further performs logarithmic scale conversion on the linear spectrogram to generate a mel spectrogram. In a case where two or more input sounds are input to the musical instrument sound generation system 300, the spectrogram transform unit 301 converts the audio waveform of each input sound into the mel spectrogram.

Here, the spectrogram corresponds to a so-called voiceprint in which spectra of respective audio data segments (frames) obtained by extracting a frequency component and an amplitude component of an audio signal from an audio waveform by Fourier transform are arranged along a time axis. In the drawings attached to the present specification, the spectrogram is illustrated as a two-dimensional graph in which the intensity (amplitude) of the signal component in each of the time component and the frequency component is visualized with shading. In addition, the mel spectrogram is a log-mel spectrogram calculated by applying a mel filter bank that extracts only a specific frequency band at equal intervals in the mel scale to a linear spectrogram, focusing on the fact that a sound of an actual frequency is not directly heard by a human ear, and a sound close to an upper limit of an audible range is heard lower than an actual sound. In addition, the melt scale is a scale based on human hearing, that is, how sound is heard.

The timbre feature extraction unit 302 extracts a timbre feature amount h from a mel spectrogram visualizing and expressing the audio waveform of the input sound. In a case where two or more input sounds are input to the musical instrument sound generation system 300, the timbre feature extraction unit 302 extracts timbre feature amounts h₁, h₂, . . . from the mel spectrogram for each input sound (not illustrated in FIG. 3).

The timbre feature extraction unit 302 extracts a timbre feature amount using, for example, a learned model configured by a convolutional neural network (CNN) and learned in advance to extract a timbre feature amount from a mel spectrogram (image information). In addition, the timbre feature amount is specifically an n-dimensional (here, n is a positive integer) feature vector.

The generation unit 303 uses the timbre feature amount, the pitch, and the random number of the input sound as inputs to generate a mel spectrogram of the musical instrument sound with a pitch reflecting the feature of the input sound. In a case where two or more input sounds are input to the musical instrument sound generation system 300 and the timbre feature extraction unit 302 extracts a plurality of timbre feature amounts (feature vectors) h₁, h₂, . . . from the mel spectrogram for each input sound, a mixture of the timbre feature amounts at a specified mixing ratio is input to the generation unit 303.

The generation unit 303 generates a mel spectrogram of the musical instrument sound with a pitch using the deep-learned generation model. Specifically, the generation unit 303 uses the learned model (generator) generated by the present disclosure model to generate a mel spectrogram of a musical instrument sound with a pitch reflecting the feature of the input sound with the timbre feature amount and the pitch of the input sound as instance conditions.

The spectrogram waveform inverse transform unit 304 performs Fourier inverse transformation on the mel spectrogram generated by the generation unit 303 to reconstruct audio waveform data including, for example, a way format file. The reconstructed audio waveform has a length of about one second or several seconds. There is a problem that the conversion processing from the mel spectrogram to the audio waveform is slow, but this point will be described later in detail.

### B-2. System Operation

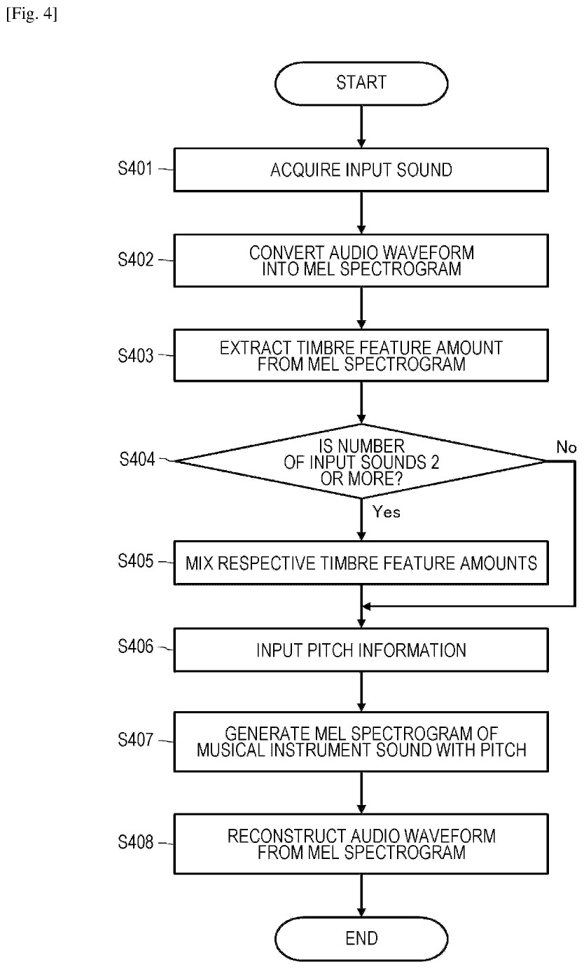

FIG. 4 illustrates a processing procedure for generating a musical instrument sound with a pitch reflecting the feature of the input sound in the musical instrument sound generation system 300 in the form of a flowchart.

First, a target input sound specified by the user is input to the musical instrument sound generation system 300 (step S401). In this step, for example, a file name of a way format file serving as a sound source of the input sound is designated. Furthermore, in a case where the user designates two or more input sounds, a way format file of each input sound is acquired in the step.

Next, the spectrogram transform unit 301 converts the audio waveform of the input sound into a mel spectrogram (step S402). That is, the spectrogram transform unit 301 generates a linear spectrogram of the input sound by Fourier transform, and further performs logarithmic scale conversion on the linear spectrogram to generate a mel spectrogram. In a case where two or more input sounds have been input in step S401, the spectrogram transform unit 301 generates a mel spectrogram for all the input sounds in step S402.

Next, the timbre feature extraction unit 302 extracts a timbre feature amount h from the mel spectrogram of the input sound (step S403).

In a case where two or more input sounds have been input in step S401 (Yes in step S404), in step S403, the timbre feature extraction unit 302 extracts the timbre feature amounts h₁, h₂, . . . from the mel spectrogram of all the input sounds, and further mixes the respective timbre feature amounts h₁, h₂, . . . to generate the timbre feature amount h (step S405).

In a case where the mixing ratio is designated for each input sound, in step S405, the timbre feature amounts h₁, h₂, . . . of each input sound are weighted average and mixed according to the designated mixing ratio. Furthermore, in a case where the mixing ratio is not specified, the timbre feature amounts h₁, h₂, . . . of the respective input sounds may be simply averaged to perform the mixing processing. Here, when N input sounds are input in step S401, the timbre feature amounts h₁, h₂, . . . , h_{N} are generated from the mel spectrogram of each input sound, respectively, and a mixing ratio rᵢ of the i-th input sound is designated (where r₁+r₂+ . . . +r_{N}=1), the mixed timbre feature amount h can be generated according to the following Expression (1) in step S405.

$$[ Math . 1 ]$$

$$h = {\sum }_{i = 1} {r}_{i} {h}_{i} / NN \qquad ( 1 )$$

Next, to the musical instrument sound generation system 300, the pitch information of the musical instrument sound to be generated, which is specified by the user, is input (step S406). However, the pitch information may be input to the musical instrument sound generation system 300 simultaneously with the input sound in step S401.

Then, the generation unit 303 generates a mel spectrogram of the musical instrument sound with a pitch reflecting the feature of the input sound from the timbre feature amount h obtained in step S403 or S405 and the pitch information obtained in step S406 (step S407). Specifically, using the learned model (generator) generated by the present disclosure model, the generation unit 303 generates a mel spectrogram of a pitched musical instrument sound reflecting the characteristics of the input sound from the random number generated by the musical instrument sound generation system 300 with the timbre feature amount and the pitch of the input sound as instance conditions.

Then, the spectrogram waveform inverse transform unit 304 performs Fourier inverse transformation on the mel spectrogram generated by the generation unit 303, reconstructs audio waveform data including, for example, a way format file, and outputs the audio waveform data as MIDI data (step S408), and ends the present processing. The output musical instrument sound has a length of about one second or several seconds.

### B-3. System Features

The configuration and operation of the sound reproduction system 300 have been schematically described above. The sound reproduction system 300 has the following features.
(1) Using the learned model, the musical instrument sound generation system 300 can generate a musical instrument sound with a pitch reflecting the timbre of the input sound in an interactive time.
(2) By using instance conditioning, the quality of generated musical instrument sounds and the ability to generate musical instrument sounds can be improved.
(3) By performing adversarial learning on the pitch for the timbre feature extractor, pitch accuracy and timbre consistency can be improved.

### B-4. System Operation

The musical instrument sound generation system 300 illustrated in FIG. 3 is mounted on an information processing apparatus including, for example, a computer or the like. Processing of generating a learned model (generator) using the model of the present disclosure and processing of generating a musical instrument sound with a pitch reflecting a feature of an input sound using the learned model (generator) have a large calculation load. Therefore, a client server model is also assumed as one operation mode of the musical instrument sound generation system 300.

In this case, on the client side, for example, the way format file of the input sound is selected (in a case where a plurality of input sounds is selected, a mixing ratio of each input sound is also specified) and the pitch is designated through a graphical user interface (GUI) operation by the user, and the server is requested to generate the musical instrument sound with a pitch reflecting the feature of the input sound. On the other hand, on the server side, a musical instrument sound with a pitch reflecting the feature of the input sound is generated with the input sound (its timbre feature amount) and the pitch designated from the client side as instance conditions, and is returned to the client as the request source. Details of this operation form will be described later (Section F).

### C. Extraction of Timbre Feature Amount

As described in the above Section B, the timbre feature extraction unit 302 extracts the timbre feature amount h from the mel spectrogram visualizing and expressing the audio waveform of the input sound. Specifically, the timbre feature extraction unit 302 is a feature extractor that uses a learned model configured by a CNN and learned in advance to extract a timbre feature amount from a mel spectrogram (image information).

It is important to use a high-quality feature extractor for learning the instance conditional GAN described in Section D below. The simplest way to obtain a feature extractor is to learn a discriminator living with labeled training data and utilize the output immediately before the final fully connected layer as the feature amount.

However, when the feature extractor learned according to the above method is applied to the timbre feature extraction unit 302, there is a problem that the pitch accuracy and the timbre consistency of the sound generated by the musical instrument sound generation system 300 are deteriorated. For example, there is a problem that while the pitch of the input sound is “Re”, the pitch of the generated sound is “Re” close to “Mi”. The following two points are considered as causes of this problem.
(a) The feature amount of the feature extractor learned by a general method includes pitch information.
(b) Since the pitch specified by the user and the pitch information included in the feature amount interfere with each other, learning of the generator (used by the generation unit 303) becomes unstable. For example, in a case where the pitch specified by the user is C4, whereas the feature amount extracted by the feature extractor includes G4 as the pitch information, the generator at the subsequent stage cannot determine which musical instrument sound of C4 or G4 may be generated.

Therefore, in the present disclosure, learning of the timbre feature extractor is performed so that the timbre feature amount in which no pitch information remains can be extracted from the mel spectrogram. Specifically, in the present disclosure, the adversarial learning regarding the pitch is performed on the timbre feature extractor so that the timbre feature amount does not remain in the timbre feature amount.

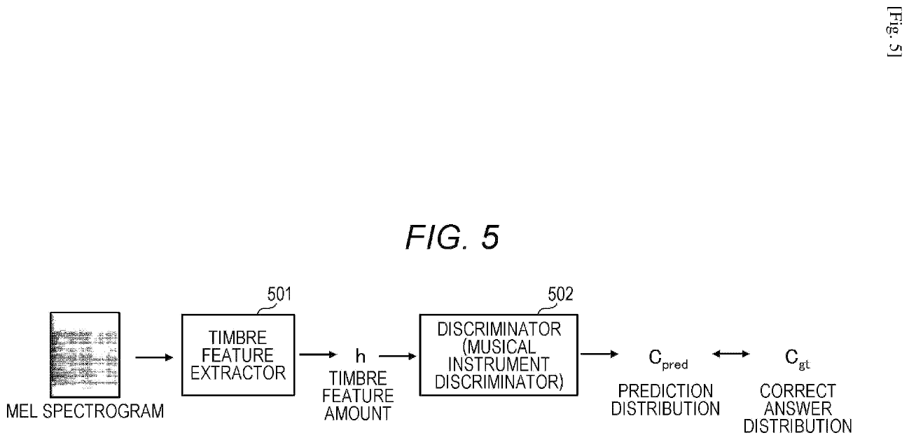

FIG. 5 illustrates an example of a workflow at the time of learning of the timbre feature extractor. In the example illustrated in FIG. 5, a timbre feature extractor 501 used in the timbre feature extraction unit 302 is learned together with a musical instrument discriminator 502. As described above, the timbre feature extractor 501 extracts the timbre feature amount h from the mel spectrogram of the audio waveform. In addition, the musical instrument discriminator 502 discriminates the musical instrument having the original audio waveform from the timbre feature amount h. Then, a prediction distribution C_{pred} output from the musical instrument discriminator 502 is compared with a correct answer distribution C_{gt}, and learning of the timbre feature extractor 501 and the musical instrument discriminator 502 is performed by error back propagation. For example, a learning phase in which the musical instrument discriminator 502 is fixed and learning of the timbre feature extractor 501 is performed and a learning phase in which the timbre feature extractor 501 is fixed and learning of the musical instrument discriminator 502 is performed are alternately repeated.

However, in the learning method illustrated in FIG. 5, it is difficult to prevent the pitch information from remaining in the feature amount h extracted by the timbre feature extractor 501. There is a problem that it is difficult to accurately generate the musical instrument sound of the specified pitch. This is because, as described in Section D below, a generator G and a discriminator D input both the timbre feature amount h and the pitch information p, and thus, if the timbre feature amount includes the pitch information, it is confused which pitch information is correct, and appropriate learning becomes difficult.

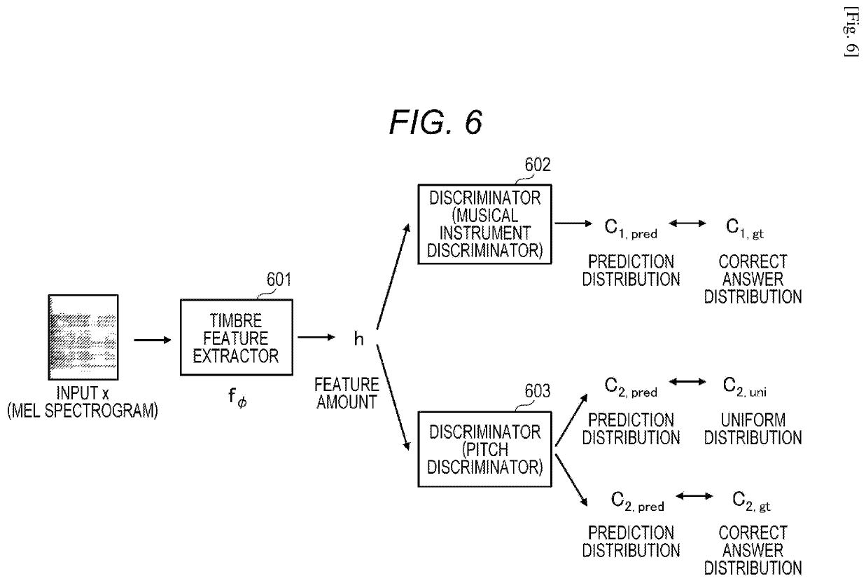

FIG. 6 illustrates a workflow at the time of learning of the timbre feature extractor in a case where adversarial learning regarding the pitch is performed so that the pitch information of the feature amount does not remain. In the example illustrated in FIG. 6, a timbre feature extractor 601 used in the timbre feature extraction unit 302 is learned together with a musical instrument discriminator 602 and a pitch discriminator 603. In particular, in the present embodiment, the musical instrument discriminator 602 and the pitch discriminator 603 are simultaneously learned, and learning is performed such that the pitch cannot be discriminated using the timbre feature amount extracted by the timbre feature extractor 601, so that it is avoided that the pitch information remains in the timbre feature amount extracted by the timbre feature extractor 601.

As described above, the timbre feature extractor 601 extracts the timbre feature amount h from the mel spectrogram of the audio waveform. In addition, the musical instrument discriminator 602 discriminates the musical instrument having the original audio waveform from the timbre feature amount h. Learning of the musical instrument discriminator 602 is similar to the case of the workflow illustrated in FIG. 5, and a detailed description thereof will be omitted here.

In addition, adversarial learning regarding the pitch is performed on the timbre feature extractor 601 so that no pitch information remains in the timbre feature amount. The pitch discriminator 603 discriminates the pitch of the original audio waveform from the timbre feature amount h.

First, the pitch discriminator 603 performs learning so that the pitch of the original audio waveform can be accurately discriminated from the timbre feature amount extracted by the timbre feature extractor 601. That is, a prediction distribution C_{2,pred} output from the pitch discriminator 603 are compared with a correct answer distributions C_{2,gt}, and the pitch discriminator 603 is learned by error back propagation. In this way, after the learning of the pitch discriminator 603 is performed, the pitch discriminator 603 is subsequently fixed, and the learning of the timbre feature extractor 601 is performed so that the timbre feature amount h in which no pitch information remains can be generated. That is, the prediction distribution C_{2,pred} output from the pitch discriminator 603 becomes a uniform distribution C_{2,uni}, in other words, learning of the timbre feature extractor 601 is performed so that the timbre feature amount h in which the key cannot be discriminated in the pitch discriminator 603 can be generated.

According to the learning method of the pitch-invariant timbre feature extractor based on adversarial learning as illustrated in FIG. 6, there is an effect of avoiding the learning of the GAN from being destabilized due to entanglement of the timbre and the pitch information in the feature amount space, and it is possible to improve the pitch accuracy and the consistency of the timbre.

Adversarial learning regarding timbre will be described more specifically. With the feature amount f_{φ}(x) (=h) as an input, shallow MLPs for which the pitch discriminator 603 performs musical instrument discrimination and pitch discrimination are denoted by Cᵢ and Cₚ, respectively. By the adversarial learning that alternately optimizes the loss functions shown in the following Expressions (2) and (3), it is possible to obtain the timbre feature extractor f_{φ} that can extract the timbre feature amount not including the pitch information.

$$[ Math . 2 ]$$

$${min}_{{f}_{ϕ} , {C}_{i}} CE ( i ( x ) , {C}_{i} ( {f}_{ϕ} ( x ) ) ) + KL ( \frac{1}{\vert p \vert} 1 p ‖ {C}_{p} ( {f}_{ϕ} ( x ) ) ) \qquad ( 2 )$$

$$[ Math . 3 ]$$

$${min}_{{C}_{p}} CE ( p ( x ) , {C}_{p} ( {f}_{ϕ} ( x ) ) ) \qquad ( 3 )$$

In the above Expressions (2) and (3), i(x) and p(x) represent the musical instrument label and the pitch label for a sample x, respectively. In addition, CE is cross entropy, and KL is Kullback-Leibler divergence.

The first term of the above Expression (2) updates the feature extractor f_{φ} and the musical instrument discrimination Cᵢ so that the musical instrument can be correctly discriminated. On the other hand, the second term of the above Expression (2) updates the timbre feature extractor f_{φ} such that it is allow to discriminate a pitch using the feature amount f_{φ}(x), that is, the prediction distribution regarding the pitch approaches a uniform distribution. On the other hand, the above Expression (3) updates Cₚ so as to maximize the pitch discrimination accuracy under the condition that the feature amount f_{φ}(x) is given. By performing such adversarial learning, it is possible to obtain a timbre feature extractor capable of extracting a timbre feature amount so that no pitch information remains.

In fact, when the learned timbre feature extractor f_{φ} is fixed and only the pitch discrimination of the discriminator 603 is learned afterwards using the above Expression (3), it has been confirmed that the pitch discrimination can be performed with an accuracy of 17% or more in a case where the adversarial learning is not used, whereas the pitch discrimination is reduced to 2.5% in the adversarial learning regarding the pitch.

### D. Generation of Musical Instrument Sound with Pitch Reflecting Characteristics of Input Sound

As described in the above Section B, the generation unit 303 uses the timbre feature amount of the input sound, the pitch, and the random number as inputs to generate the mel spectrogram of the musical instrument sound with a pitch reflecting the feature of the input sound. Specifically, the generation unit 303 uses the learned model (generator) generated by the present disclosure model to generate a mel spectrogram of a musical instrument sound with a pitch reflecting the feature of the input sound with the timbre feature amount and the pitch of the input sound as instance conditions.

Here, as already known in the art, the GAN is a deep learning model that makes two neural networks, a discriminator (D) that discriminates between true data and artificial data, and a generator (G) that generates data from noise, compete to learn. In the GAN, there is a problem of mode collapse in which the quality and diversity of the generated sample are impaired because the generated data is biased to a part in the training data. On the other hand, the IC-GAN is a new technique of learning the GAN that solves the problem of the mode collapse by conditioning the discriminator D and the generator G by the feature amount corresponding to the data point (instance) and teaching the vicinity of the data point to the discriminator as true data.

FIG. 27 illustrates an outline of a model of IC-GAN (for example, see NPL 1). The discriminator D and the generator G are mounted using DNNs, respectively. In the drawing, the input image xᵢ as an instance is mapped to the feature amount space by the feature extractor f_{φ}. Then, the feature amount hᵢ of the image xᵢ obtained as the output of the feature extractor f_{φ} is input to each of the generator G and the discriminator D. The generator G generates an image x_{g} from the feature amount hᵢ extracted from the instance xᵢ and the sampled noise (random number) z. In addition, the discriminator D discriminates the image x_{g} generated by the generator G based on the feature amount hᵢ and the neighboring image xₙ which is the actual sample. Then, the generator G causes the discriminator D to learn so as to compete with each other so as to be able to discriminate the generated image x_{g} and the neighboring image xₙ generated by the generator G such that the discriminator D can make the generated image x_{g} indistinguishable from the neighboring image xₙ. As a result, it is possible to obtain the generator G that generates a precise image X_{g} that makes it not allowed to determine the authenticity in the discriminator D.

In the present embodiment, the feature extractor f_{φ} corresponds to the timbre feature extraction unit 302, and the generator G corresponds to the generation unit 303. Then, the input image xᵢ corresponds to the mel spectrogram visualizing the input sound, the feature amount hᵢ corresponds to the timbre feature amount, and the generated image x_{g} corresponds to the mel spectrogram generated by the generator G.

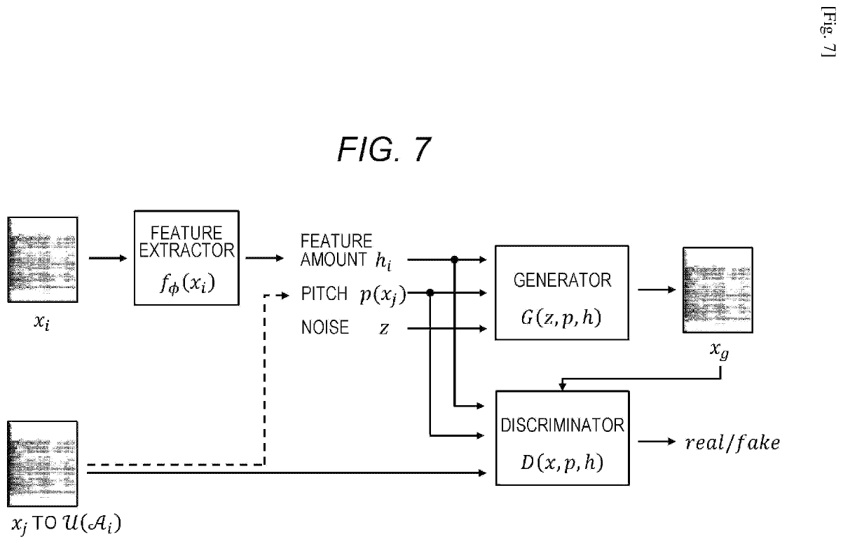

The present disclosure model is a generation model learned by a GAN framework that generates musical instrument sounds using the idea of the IC-GAN (described above). FIG. 7 illustrates an outline of the present disclosure model in a case where the generator used in the generation unit 303 of the musical instrument sound generation system 300 is learned. The generator G in this case generates a musical instrument sound with a pitch reflecting the feature of the input sound from the input sound, the pitch information p, and the noise vector z. In addition, the discriminator D discriminates true/false of the sound generated by the generator G.

The input sound is converted into a log-scale mel spectrogram xᵢ by short-time Fourier transform in the spectrogram transform unit 301. Then, the timbre feature extraction unit 302 maps the mel spectrogram xᵢ to the timbre feature amount hᵢ using the feature extractor f_{φ} described in the above Section C. The generator G inputs the one-shot vector of the pitch information p and the noise vector z sampled from the standard normal distribution together with the timbre feature amount hᵢ to generate a mel spectrogram x_{g}. The generated mel spectrogram is reconstructed into an audio waveform by the spectrogram waveform inverse transform unit 304 described in Section E described later. The audio waveform is a musical instrument sound with a pitch reflecting the characteristics of the input sound.

General class conditioning divides the distribution of the entire data into a plurality of distributions with no overlap by the number of classes. On the other hand, instance conditioning in IC-GAN (see NPL 1) attempts to obtain a complex data distribution by dividing the distribution of the entire data into a large number of local distributions with overlap. By conditioning both the generator G and the discriminator D using the feature amount hᵢ=f_{φ}(x) of the instance xᵢ and the one-shot vector p of the pitch information, the local distribution P(x|hᵢ, p) in the vicinity of the instance xᵢ is modeled, and the distribution P(x) of the entire data is expressed as the following Expression (4) as a superposition thereof.

$$[ Math . 4 ]$$

$$P ( x ) = {\sum }_{{x}_{i}} {\sum }_{p} p ( x \vert {h}_{i} , p ) \qquad ( 4 )$$

The learning procedure of the generation model follows NPL 1. With respect to the input xᵢ, a data set of saikiobo whose L2 distance is k in the feature amount space defined by the learned feature extractor f_{φ}(⋅) is set as Aᵢ. At this time, as illustrated in FIG. 7, the neighboring data point xⱼ is sampled from Aᵢ on the basis of the uniform distribution. xⱼ is used for learning of the discriminator D together with the generation sample x_{g} as a real sample. In addition, the pitch p(xⱼ) corresponding to the real sample xⱼ is input to the generator G and the discriminator D as a condition. In the present embodiment, the generator G and the discriminator D are optimized through a min-max game shown in the following Expression (5).

$$[ Math . 5 ]$$

$${min}_{G} {max}_{D} {𝔼}_{{x}_{i} ∼ P ( x ) , {x}_{j} ∼ 𝒰 ( {𝒜}_{i} )} [ log D ( {x}_{j} , p ( {x}_{j} ) , {h}_{j} ) ] + {𝔼}_{{x}_{i} ∼ P ( x ) , z \sim P ( z )} [ log ( 1 - D ( G ( z , p ( {x}_{j} ) , {h}_{i} ) , p ( {x}_{j} ) , {h}_{i} ) ) ] \qquad ( 5 )$$

### E. Reconstruction of Audio Waveform

Methods for reconstructing audio waveform data from a mel spectrogram mainly include two approaches based on learning paste optimization. In the text-to-speech field, an approach of acquiring a vocoder by learning has been actively studied. However, the present disclosure is intended to generate musical instrument sounds of various timbres and pitches, and it is not necessarily easy to acquire a general-purpose vocoder capable of coping with such generated sounds. On the other hand, there is a research result that by generating a high-resolution mel spectrogram in the frequency direction, various sounds including music can be synthesized at a certain level of sound quality even in a case where optimization-based audio inversion is used (see NPL 5). Therefore, in the present disclosure, the audio waveform data is reconstructed from the mel spectrogram by adopting an optimization-based approach.

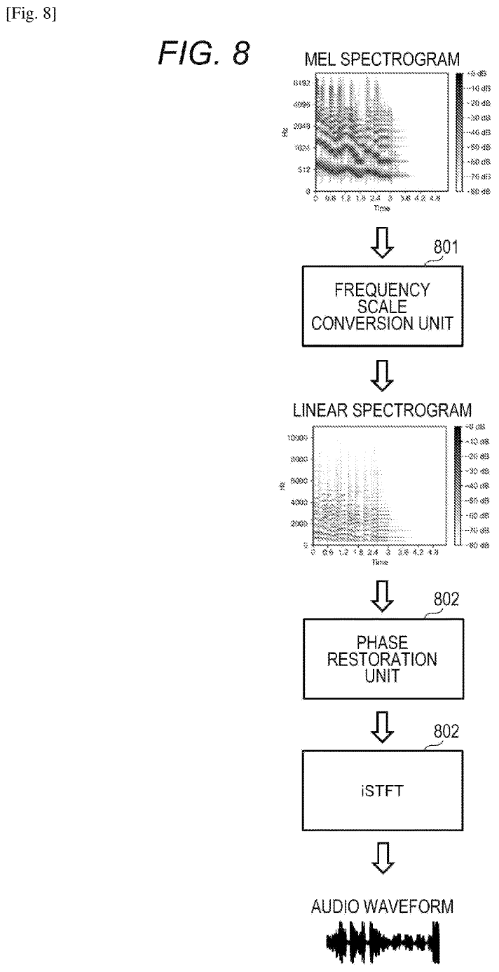

FIG. 8 schematically illustrates a general processing flow of reconstructing audio waveform data from a mel spectrogram by an optimization-based approach.

The mel spectrogram is a log-mel spectrogram calculated by applying a mel filter bank that extracts only a specific frequency band at equal intervals in a mel scale based on human hearing to a linear spectrogram. Therefore, a frequency scale conversion unit 801 converts the mel spectrogram generated by the generation unit 303 into a linear spectrogram on a frequency scale. Next, a phase restoration unit 802 restores the phase of the linear spectrogram using, for example, a known Griffin-Lim algorithm. Then, an inverse short-time Fourier transform unit (iSTFT) 803 performs inverse Fourier transform to reconstruct the audio waveform. This audio waveform is an audio waveform of a musical instrument sound with a pitch generated by the musical instrument sound generation system 300.

In the processing flow illustrated in FIG. 8, in particular, the processing in which the frequency scale conversion unit 801 performs the frequency scale conversion of the mel spectrogram into the linear spectrogram has a problem that the calculation cost is high and the processing becomes a bottleneck. The frequency scale conversion from the mel spectrogram to the linear spectrogram can be formulated as a non-negative value constrained least squares problem as in the following Expression (6), but a general solution has a large calculation amount. In the following Expression (6), Fₘₑₗ is a mel filter bank matrix, xₘₑₗ is a mel-scale spectrogram, and xₗᵢₙ is a linear scale spectrogram.

$$[ Math . 6 ]$$

$${min}_{{x}_{lin}} {‖ {F}_{mel} {x}_{lin} - {x}_{mel} ‖}^{2} s . t . {x}_{lin} \geq 0 \qquad ( 6 )$$

In addition, an approach of obtaining a good solution by an iterative method of repeating update by a gradient method and correction to a non-negative value is conceivable. However, since the initial value is set by a random number, a sufficient number of iterations are required for convergence to a good solution.

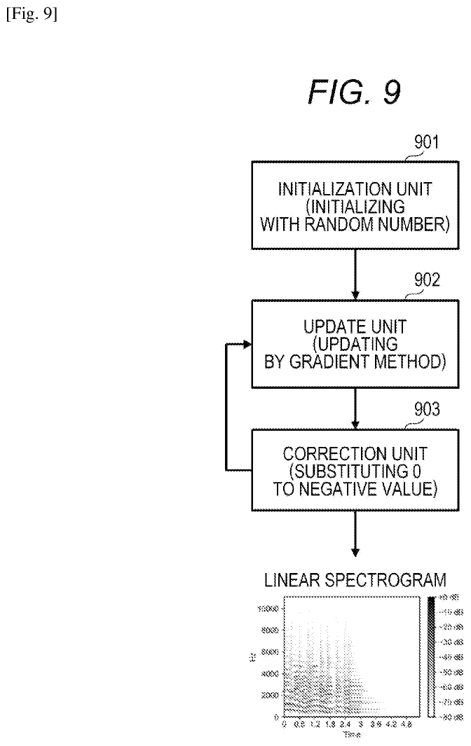

FIG. 9 illustrates an outline of a frequency scale conversion processing flow by an iterative method of repeating update by a gradient method and correction to a non-negative value. In the related art, a software library for performing frequency scale conversion on the basis of the illustrated processing flow is already provided. In this processing flow, first, an initialization unit 901 initializes the spectrogram with a random number (for example, the intensity (amplitude) of each point on the time axis and the frequency axis is given as a random number). Then, an update unit 902 updates the intensity (amplitude) of each point on the time axis and the frequency axis by the gradient method, and then a correction unit 903 substitutes 0 into the variable having the negative value. Processing by the update unit 902 and the correction unit 903 is repeatedly performed until the calculation results converge. As already mentioned, the iterative method of repeating the update by the gradient method and the correction to the non-negative value is efficient, but the convergence speed is slow.

Therefore, in the present disclosure, a similar iterative method is basically used, but a solution of a least squares method without a non-negative value constraint is used instead of a random number for spectrum initialization. Specifically, after obtaining a solution of the least squares method without constraint that can be calculated at high speed (see the following Expression (7)), a solution obtained by correcting the solution to a non-negative value is set as an initial value of iterative calculation, so that it is possible to converge to a good solution with a small number of iterations. Therefore, it has been confirmed by experiments that the solution converges to the same degree of accuracy with the number of iterations of about 1/10.

$$[ Math . 7 ]$$

$${min}_{{x}_{lin}} {‖ {F}_{mel} {x}_{lin} - {x}_{mel} ‖}^{2} \qquad ( 7 )$$

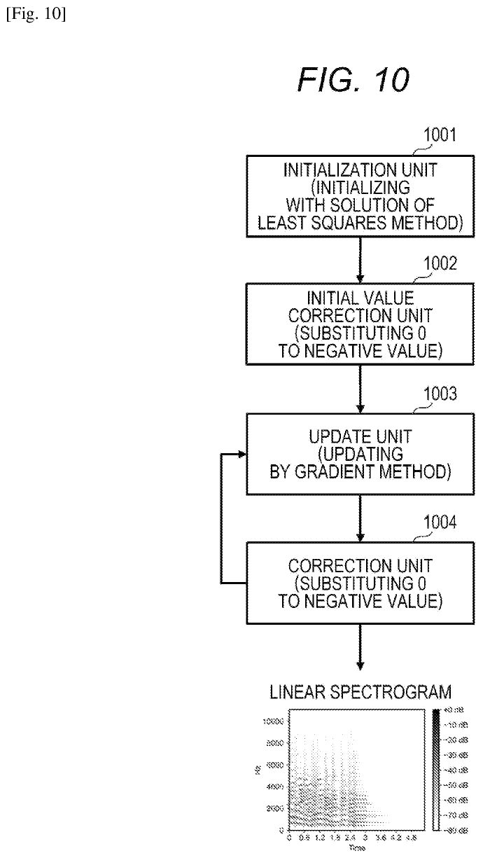

FIG. 10 schematically illustrates a frequency scale conversion processing flow in a case where the solution of the least squares method without a non-negative value constraint is utilized instead of the random number in the iterative method similar to FIG. 9. First, an initialization unit 1001 initializes the spectrogram with the solution of the least squares method without constraint, and at that time, an initial value correction unit 1002 substitutes 0 into the variable having a negative value. Then, an update unit 1003 updates the intensity (amplitude) of each point on the time axis and the frequency axis by the gradient method, and then a correction unit 1004 substitutes 0 into the variable having the negative value. Processing by the update unit 1003 and the correction unit 1004 is repeatedly performed until the calculation results converge.

According to the frequency scale conversion method illustrated in FIG. 10, the solution obtained by replacing the negative value with 0 in the solution of the least squares method is set to the initial value of the iterative calculation, so that it is possible to converge to a satisfactory level with a small number of iterations. As a result, the musical instrument sound generation system 300 can realize the generation of the musical instrument sound within the interactive time.

### F. Operational Form by Client Server Model

The musical instrument sound generation system 300 is mounted on an information processing apparatus including, for example, a computer or the like. Processing of generating a learned model (generator) using the model of the present disclosure and processing of generating a musical instrument sound with a pitch reflecting a feature of an input sound using the learned model (generator) have a large calculation load. Therefore, a client server model is assumed as one operation mode of the musical instrument sound generation system 300.

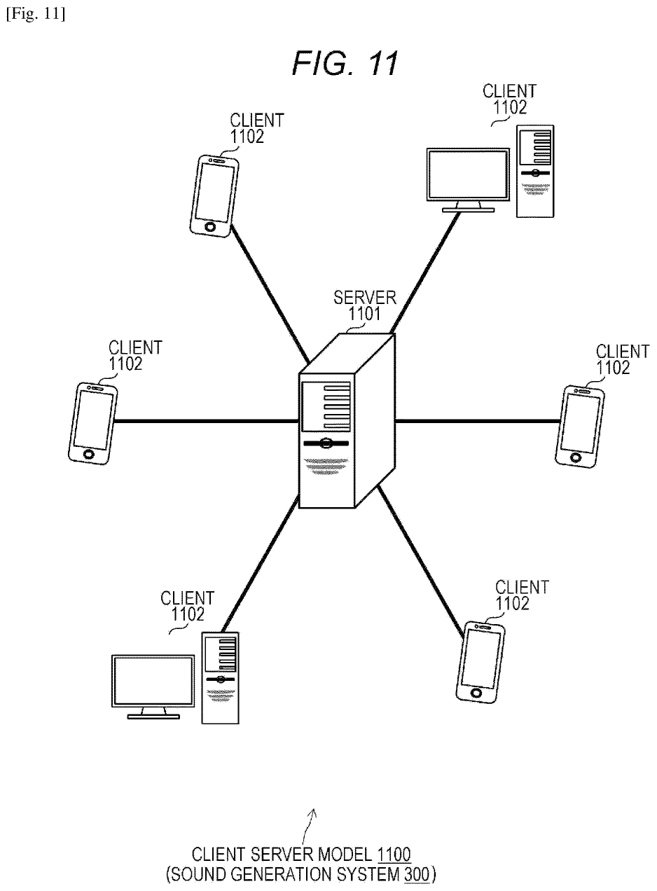

FIG. 11 schematically illustrates a configuration of the musical instrument sound generation system 300 including a client server model 1100. The client server model 1100 includes a server 1101 that provides a generation service of musical instrument sound with a pitch and one or more clients 1102 that request to generate musical instrument sounds with a pitch. The server 1101 and each client 1102 are interconnected via a network such as a wide area network (WAN), a local area network (LAN), or the Internet.

The client 1102 includes, for example, an information terminal (edge device) such as a smartphone, a tablet, or a personal computer (PC) used by the user. The user mentioned here is, for example, a general user who composes music or performs other music activities using a unique musical instrument sound provided from the server 1101. On the client 1102 side, for example, GUI operations such as selection of a way format file of the input sound and designation of a pitch are performed via the GUI screen. At that time, in a case where a plurality of input sounds is selected, designation of a mixing ratio of each input sound is also included in the GUI operation. Then, the client 1102 requests the server 1101 to perform a process of generating a musical instrument sound with a pitch reflecting the feature of the input sound.

The server 1101 includes, for example, an information processing apparatus such as a computer, and is equipped with the main components 301 to 304 of the musical instrument sound generation system 300. In response to the request from the client 1102, the server 1101 generates a musical instrument sound with a pitch reflecting the feature of the input sound using the learned model (generator) generated using the present disclosure model with the specified input sound and pitch as instance conditions, and returns the musical instrument sound with a pitch to the client 1102 as the request source. Furthermore, in a case where a plurality of input sounds is requested from the client 102, the server 1101 generates a musical instrument sound with a pitch by using a feature vector obtained by combining feature vectors of the respective input sounds at a mixing ratio specified by the client 1102, and returns the musical instrument sound to the client 1102.

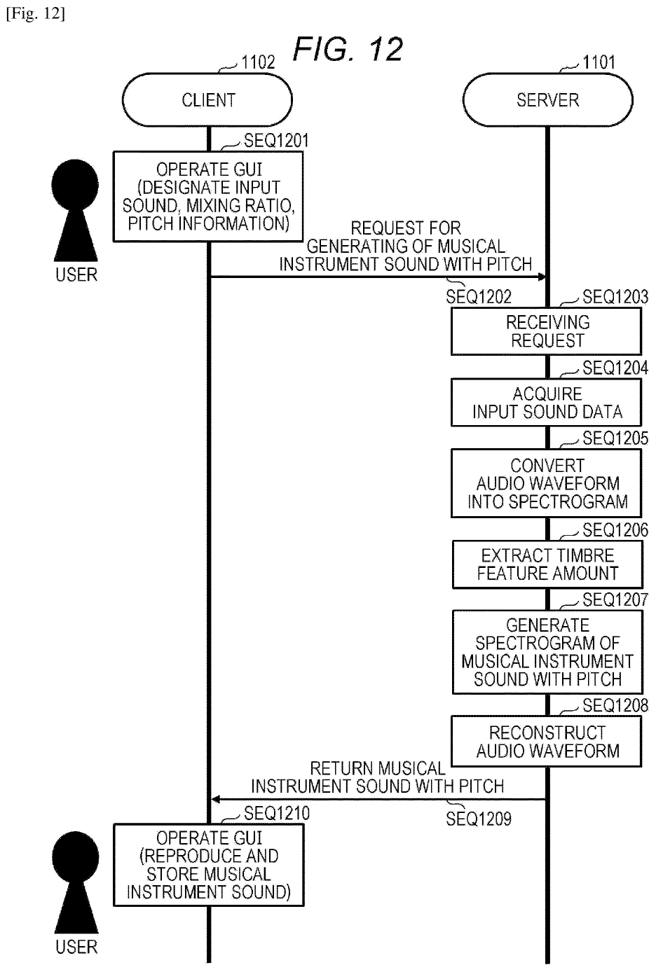

FIG. 12 illustrates an exemplary processing sequence performed by the client 1102 and the server 1101.

On the client 1102 side, the user designates the input sound serving as the sound source for generating the musical instrument sound and the pitch of the musical instrument sound to be generated through the GUI operation (SEQ 1201).

The input sound is designated in a form in which the file name of the corresponding way format file is designated from the presets. For example, a way format file prepared in advance on the server 1101 side, a way format file that can be designated on the client 1102 side and can be acquired by the server 1101, and a way format file that can be uploaded from the client 1102 to the server 1101 can also be designated as the preset of the input sound. Furthermore, the user can designate two or more input sounds, and in a case where a plurality of input sounds is designated, the user can further designate a mixing ratio of each input sound.

Then, the client 1102 transmits a request for generating a musical instrument sound with a pitch to the server 1101 (SEQ 1202). The request includes information of the input sound and the pitch specified by the user. In a case where the user specifies a plurality of input sounds, the request also includes a mixing ratio of the respective input sounds.

When receiving a request from the client 1102 (SEQ 1203), the server 1101 first acquires an input sound specified by the request (SEQ 1204). The server 1101 may acquire the way format file of the designated input sound from its own local disk or from an external accumulation device via a network. Furthermore, the server 1101 may acquire a way format file uploaded from the client 1102.

Next, the server 1101 converts the audio waveform of the input sound into a mel spectrogram using the spectrogram transform unit 301 (SEQ 1205). In a case where the request from the client 1102 specifies a plurality of input sounds, the server 1101 converts the audio waveforms of all the input sounds into the mel spectrogram.

Next, the server 1101 uses the timbre feature extraction unit 302 to extract the timbre feature amount h from the mel spectrogram of the input sound (SEQ 1206). In a case where a request from the client 1102 specifies a plurality of input sounds, a mel spectrogram generated from each input sound is mixed at a specified mixing ratio to calculate a timbre feature amount h according to the above Expression (1).

Next, the server 1101 uses the generation unit 303 to generate the mel spectrogram of the musical instrument sound including the pitch specified by the request from the client 1102 from the timbre feature amount h extracted from the mel spectrogram of the input sound (SEQ 1207). Specifically, using the learned model (generator) generated by the present disclosure model, the generation unit 303 generates a mel spectrogram of the musical instrument sound with a pitch reflecting the feature of the input sound from the random number generated by the musical instrument sound generation system 300 with the timbre feature amount and the pitch of the input sound as instance conditions.

Next, the server 1101 reconstructs the audio waveform from the generated mel spectrogram using the spectrogram waveform inverse transform unit 304 (SEQ 1208). The audio waveform is a musical instrument sound with a pitch reflecting the feature of the input sound, and the output musical instrument sound has a length of about one second or several seconds. It is output as MIDI data.

Then, the server 1101 returns the generated data of the musical instrument sound with a pitch to the client 1102 as the request source (SEQ 1209). Note that the server 1101 may return information of the mel spectrogram before reconstruction together with the reconstructed audio waveform. Furthermore, the server 1101 may stream the data of the musical instrument sound or may transmit the file itself to the client 1102.

Upon receiving the MIDI data of the musical instrument sound with a pitch from the server 1101 (SEQ 1209), the client 1102 can reproduce (listen to the user) and store the musical instrument sound according to the user's GUI operation (SEQ 1210). Furthermore, the user can further request generation of a next musical instrument sound by a GUI operation.

### G. Configuration and Operation Example of GUI

In this Section G, a GUI screen and a GUI operation for requesting generation of a musical instrument sound with a pitch on the client 1102 side and instructing processing such as reproduction and storage of the generated musical instrument sound with a pitch will be described. In a case where a sound reproduction system 300 is mounted as a client server model as described in Section F, the GUI operation described in Section G is performed on the terminal of the client. Note that, in a case where the sound reproduction system 300 is mounted on a single information processing apparatus, the GUI operation described in Section G is performed using the console of the information processing apparatus.

### G-1. First Example

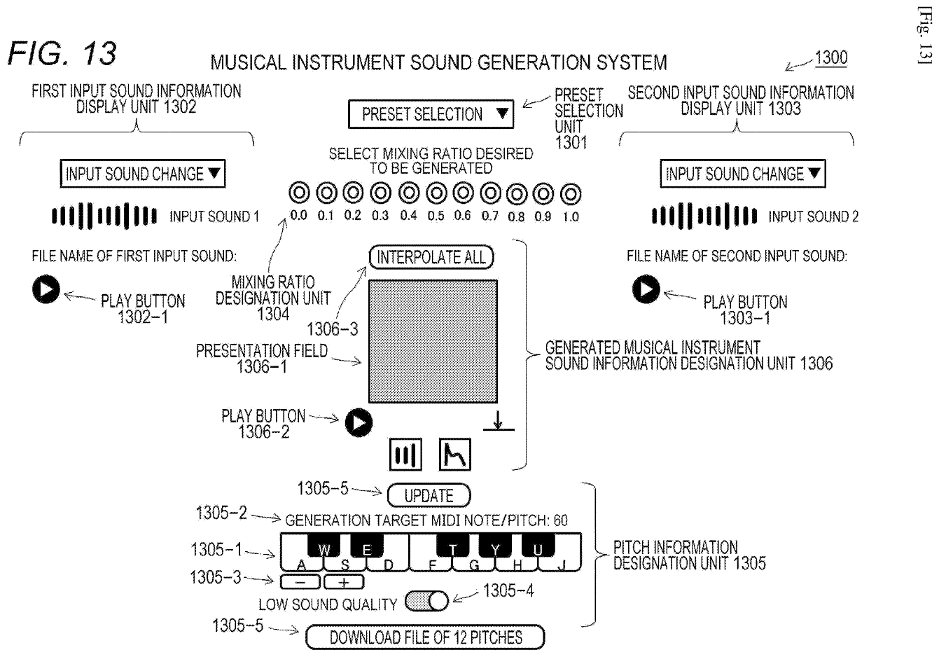

FIG. 13 illustrates a configuration example of a GUI screen for generating and reproducing a musical instrument sound with a pitch according to the present disclosure. Note that FIG. 13 illustrates a configuration of a GUI screen used in a case where two input sounds are combined to generate a musical instrument sound with a pitch. In the present disclosure, it is also possible to generate a musical instrument sound with a pitch on the basis of three or more input sounds. The configuration and operation of the GUI screen used in a case where the three input sounds are designated to generate the musical instrument sound with a pitch will be described later.

A GUI screen 1300 illustrated in FIG. 13 includes, as input/output fields, a preset selection unit 1301, a first input sound information display unit 1302, a second input sound information display unit 1303, a mixing ratio designation unit 1304, a pitch information designation unit 1305, and a generated musical instrument sound information presentation unit 1306.

The preset selection unit 1301 is a GUI component that selects sound sources of the first input sound and the second input sound via a pull-down menu. The pull-down menu includes a list of presets (file names of way format files) that can be selected as input sounds prepared in advance by the musical instrument sound generation system 300 (alternatively, the server 1101) (not illustrated). The way format file selected by the user on this pull-down menu is sequentially designated as the first input sound and the second input sound.

The first input sound information display unit 1302 and the second input sound information display unit 1303 display the file names of the way format files of the first input sound and the second input sound specified through the preset selection unit 1301. In addition, each of the first input sound information display unit 1302 and the second input sound information display unit 1303 has a pull-down menu for changing the input sound. Each of the pull-down menus of the first input sound information display unit 1302 and the second input sound information display unit 1303 is not a preset prepared by the musical instrument sound generation system 300 (alternatively, the server 1101) in advance, but a list of file names of way format files that can be independently selected as an input sound in the client (alternatively, the information processing apparatus). The user can also select the first input sound and the second input sound using the respective pull-down menus of the first input sound information display unit 1302 and the second input sound information display unit 1303.

The first input sound information display unit 1302 and the second input sound information display unit 1303 respectively include play buttons 1302-1 and 1303-1 for instructing reproduction of a way format file designated as an input sound. Using these play buttons 1302-1 and 1303-1, the user can reproduce and listen to each way format file designated as the input sound to confirm whether or not the sound source is the sound source desired by the user before requesting generation of the musical instrument sound.

The mixing ratio designation unit 1304 is an input field for the user to designate the mixing ratio of the two input sounds set in the first input sound information display unit 1302 and the second input sound information display unit 1303. In the example illustrated in FIG. 13, the mixing ratio designation unit 1304 includes radio buttons for selectively designating the mixing ratios 0.0, 0.1, 0.2, . . . , 0.8, 0.9, and 1.0 of the second input sound to the first input sound. A mixing ratio closer to 0.0 can request generation of a musical instrument sound that more captures the feature of the first input sound, and a mixing ratio closer to 1.0 can request generation of a musical instrument sound that more captures the feature of the second input sound. The mixing ratio 0.0 means that a single sound of only the first input sound is designated, and the mixing ratio 1.0 means that a single sound of only the second input sound is designated, and the musical instrument sound generation can be requested from the features of the single sounds.

In the GUI screen configuration example illustrated in FIG. 13, the pitch information designation unit 1305 is disposed at the bottom of the screen. The pitch information designation unit 1305 includes a design (hereinafter, it is simply referred to as a “keyboard”) 1305-1 using a layout of piano keys. The user can specify the pitch of the musical instrument sound to be generated by clicking or touching a key in the keyboard 1305-1. Since the text 1305-2 (in the example shown in FIG. 13, the text “generation target MIDI note/pitch:60” is displayed) indicating the pitch to be generated is displayed near the top of the keyboard 1305-1, the user can visually confirm the text.

A pair of positive and negative buttons 1305-3 is disposed near the lower left end of the keyboard 1305-1. The user can indicate up or down of the octave by selecting the “+” button and the “−” button. Therefore, it is possible to specify a pitch of 88 pitches from A-1 to C7.

In addition, a toggle switch 1305-4 for switching between two states of on and off of “low sound quality” is disposed in a lower central portion of the keyboard 1305-1. When the toggle switch 1305-4 is used to toggle to the on state of “low sound quality”, a musical instrument sound reflecting the features of the input sound is generated with low sound quality. On the other hand, when the toggle switch 1305-4 is used to toggle to the off state of “low sound quality”, a musical instrument sound reflecting the characteristics of the input sound is generated with high sound quality.

Furthermore, the pitch information designation unit 1305 includes an “update” button 1305-5 at substantially the center above the keyboard 1305-1. In a case where the user desires to generate the musical instrument sound having the same feature with another pitch, the user can instruct to regenerate the same musical instrument sound with another pitch by selecting the update button 1305-5 after specifying a pitch corresponding to another desired pitch from the keyboard 1305-1 by clicking or touching.

When the user selects one of the keys on the keyboard 1305-1 on the pitch information designation unit 1305, a request for generating a musical instrument sound with a pitch is output to the server 1101 (alternatively, the process of generating a musical instrument sound with a pitch is activated in the information processing apparatus).

On the side of the server 1101 (alternatively, in the information processing apparatus), the audio waveforms of the respective input sounds of the first input sound and the second input sound are converted into mel spectrograms, timbre feature amounts are extracted from the respective mel spectrograms, and are mixed at a specified mixing ratio, and then a musical instrument sound with a pitch is generated with specified sound quality (either high sound quality or low sound quality) using the timbre feature amounts and the pitch information as instance conditions. On the other hand, on the client 1102 side, the musical instrument sound with a pitch generated on the server 1101 side is streamed and reproduced (alternatively, it is downloaded and reproduced and output) (However, in a case where a musical instrument sound with a pitch is generated inside the information processing apparatus, the information processing apparatus reproduces and outputs the generated sound).

The generated musical instrument sound information presentation unit 1306 includes a presentation field 1306-1 that presents information regarding the generated musical instrument sound with a pitch. The “information regarding the musical instrument sound with a pitch” to be presented is not particularly limited. For example, information that visually expresses the characteristics of the audio waveform of the musical instrument sound, such as a mel spectrogram (alternatively, the frequency spectrogram), may be displayed in the presentation field 1306-1 (described later). Of course, instead of the spectrogram, the audio waveform of the musical instrument sound may be displayed in the presentation field 1306-1.

In addition, the generated musical instrument sound information presentation unit 1306 includes a play button 1306-2. The user can reproduce and listen to the generated musical instrument sound with a pitch by using the play button 1306-2, and check whether or not the pitch and the musical instrument sound reflect the feature of the specified input sound as expected.

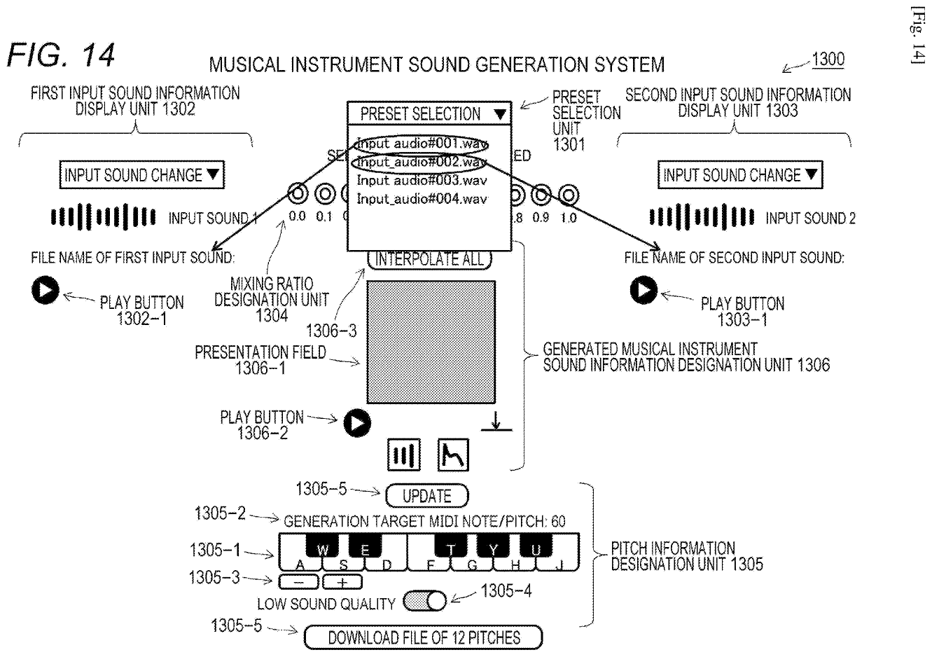

Hereinafter, an operation example on the GUI screen illustrated in FIG. 13 will be described with reference to FIGS. 14 to 23.

FIG. 14 illustrates a state in which file names to be used as the first input sound and the second input sound are sequentially designated from a list of file names of way format files displayed on a pull-down menu 1401 of the preset selection unit 1301. The files specified in the pull-down menu 1401 are displayed on the first input sound information display unit 1302 and the second input sound information display unit 1303, respectively. In the example illustrated in FIG. 14, audio files “Input_audio#001.wav” and “Input_audio#002.wav” are designated on the pull-down menu 1401.

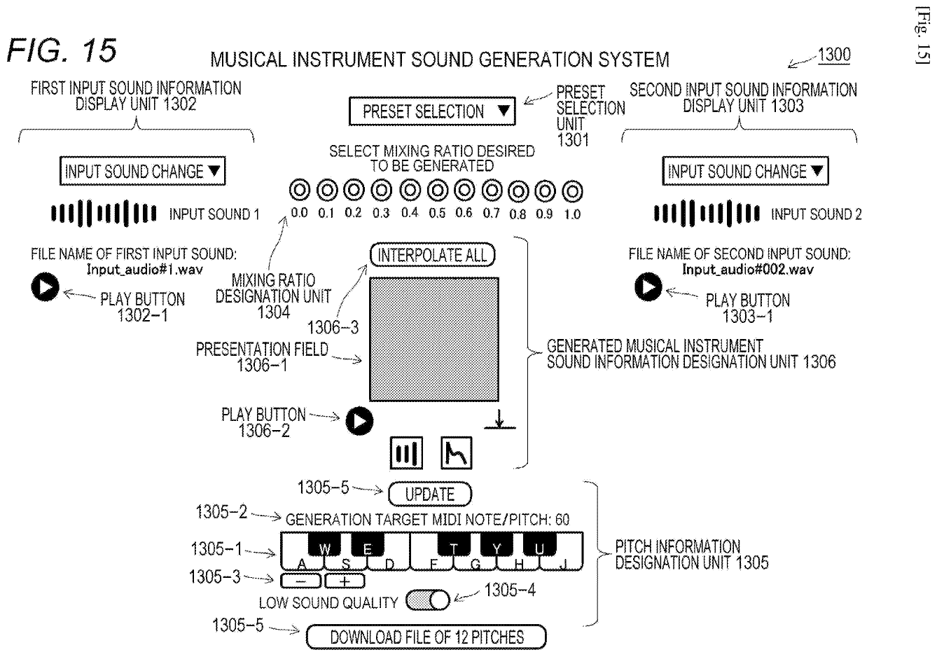

FIG. 15 illustrates a state in which the respective file names are displayed on the first input sound information display unit 1302 and the second input sound information display unit 1303 in response to the designation of the audio files “input_audio#001.wav” and “input_audio#002.wav” on the pull-down menu 1401. The user can visually confirm the combination of the input sounds used to generate the musical instrument sound with a pitch from the file names displayed on the first input sound information display unit 1302 and the second input sound information display unit 1303. Moreover, the user can individually reproduce each way format file “input_audio#001.wav” and “input_audio#002.wav” designated as the input sound by using the play button 1302-1 of the first input sound information display unit 1302 and the play button 1303-1 of the second input sound information display unit 1303, and confirm the combination of the input sounds used to generate the musical instrument sound with a pitch by listening.

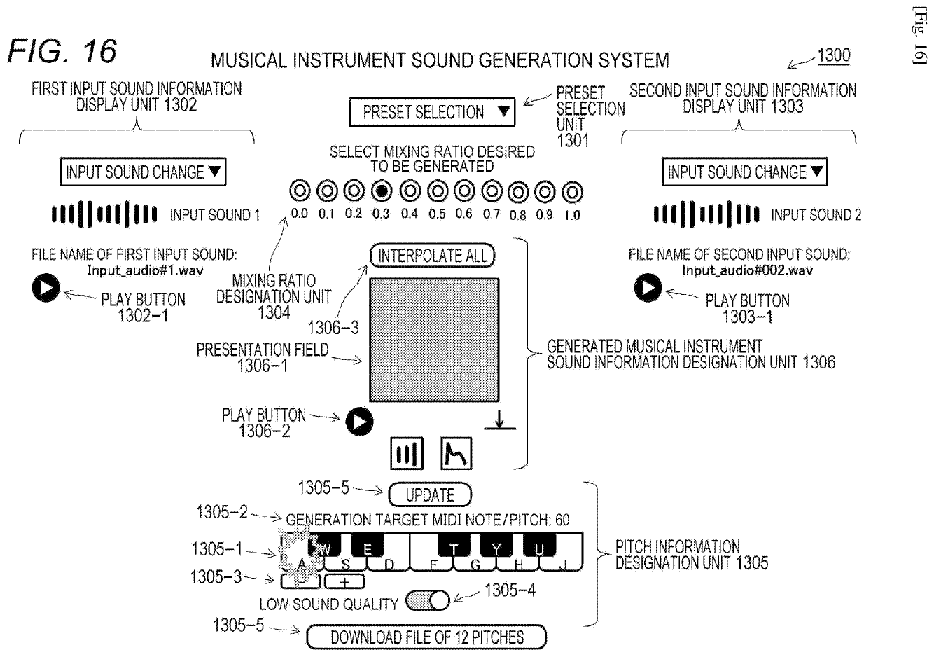

FIG. 16 illustrates a state in which the radio buttons of the mixing ratio designation unit 1304 are used to designate the mixing ratios of the audio waveforms of “input_audio#001.wav” and “input_audio#002.wav” designated as the first input sound and the second input sound, respectively. The mixing ratio designation unit 1304 includes radio buttons that alternatively designate mixing ratios 0.0, 0.1, 0.2, . . . , 0.8, 0.9, and 1.0 of the second input sound with respect to the first input sound. A mixing ratio closer to 0.0 can request generation of a musical instrument sound capturing a feature of the first input sound, and a mixing ratio closer to 1.0 can request generation of a musical instrument sound capturing a feature of the second input sound (described above). In the example shown in FIG. 16, a mixing ratio 0.3 is designated.

FIG. 16 further illustrates a state in which the pitch of the musical instrument sound to be generated is designated using the pitch information designation unit 1305. The pitch information designation unit 1305 has a design using a layout of a keyboard of a piano, and characters representing the corresponding pitch are displayed on each key of the keyboard 1305-1. Further, it is possible to instruct the up and down of the octave using a plus/minus button 1305-3 disposed near the lower left end of the keyboard 1305-1. Therefore, the user can designate the 88 pitches from A-1 to C7 by combining the operations of the keyboard 1305-1 and the plus/minus button 1305-3 of the pitch information designation unit 1305 (described above). Note that the toggle switch 1305-4 for switching on/off of “low sound quality” is toggled to “off”.

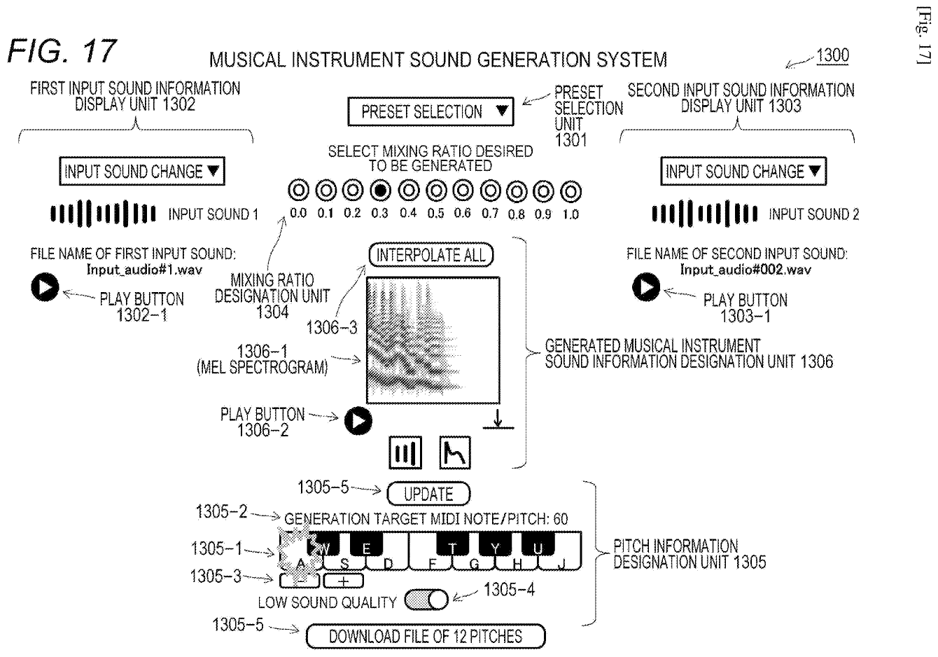

When the user selects any key (in the example illustrated in FIG. 16, a key “A” is set) of the keyboard 1305-1 on the pitch information designation unit 1305, a request for generating a musical instrument sound with a pitch is output to the server 1101 (alternatively, the process of generating a musical instrument sound with a pitch is activated in the information processing apparatus). Then, a musical instrument sound with a pitch reflecting the feature of the input sound is reproduced for a relatively short time of about 1 second or several seconds (or is generated inside the information processing apparatus) generated on the server 1101 side. FIG. 17 illustrates a state in which a mel spectrogram of the musical instrument sound is displayed in the presentation field 1306-1 of the generated musical instrument sound information presentation unit 1306 in accordance with reproduction of the musical instrument sound. The presentation field 1306-1 reflects the mel spectrogram generated corresponding to the mixing ratio designated by the mixing ratio designation unit 1304. When another radio button is selected in the mixing ratio designation unit 1304, on/off display of the radio button is switched in the mixing ratio designation unit 1304 (not illustrated), the mel spectrogram in the presentation field 1306-1 is reflected in the musical instrument sound corresponding to the newly selected mixing ratio, and the user can listen to and confirm the musical instrument sound.

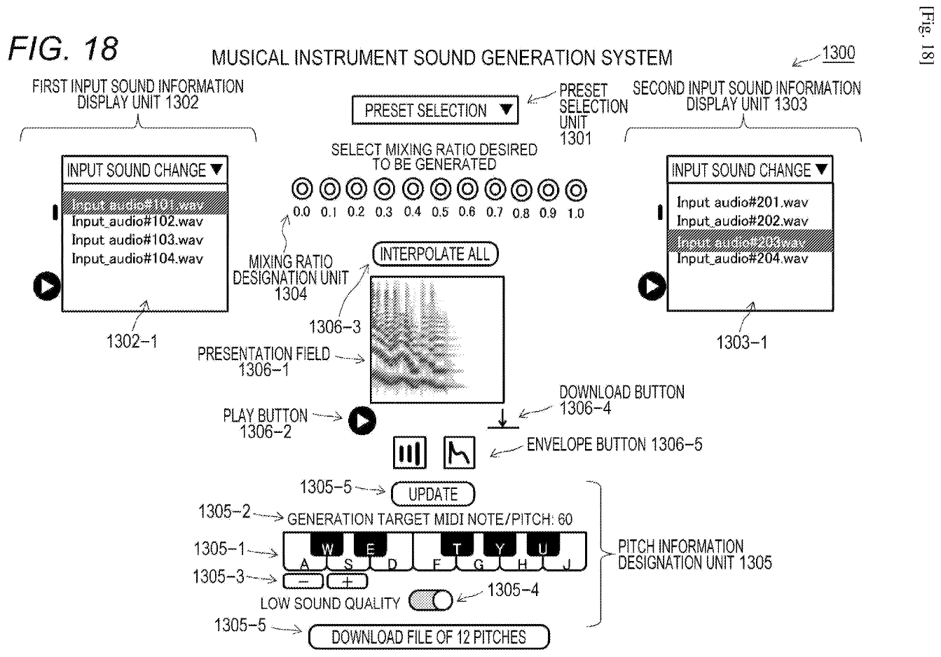

In a case where the user wants to search for a sample of another musical instrument sound, the user can select a preset again through the preset selection unit 1301, or individually change the first input sound and the second input sound through the first input sound information display unit 1302 and the second input sound information display unit 1303. FIG. 18 illustrates a state in which the first input sound and the second input sound are individually changed from the pull-down menus of the first input sound information display unit 1302 and the second input sound information display unit 1303. In the example illustrated in FIG. 18, the first input sound is changed to an audio file “input_audio#101.wav” by a selection operation on the pull-down menu 1302-2 of the first input sound information display unit 1302. In addition, the second input sound is changed to “input_audio#203.wav” by a selection operation on the pull-down menu 1303-2 of the second input sound information display unit 1303. The operation related to the designation of the mixing ratio, the designation of the pitch information, and the reproduction of the generated musical instrument sound with a pitch after each input sound is individually changed is similar to the above description, and thus the description thereof will be omitted here.

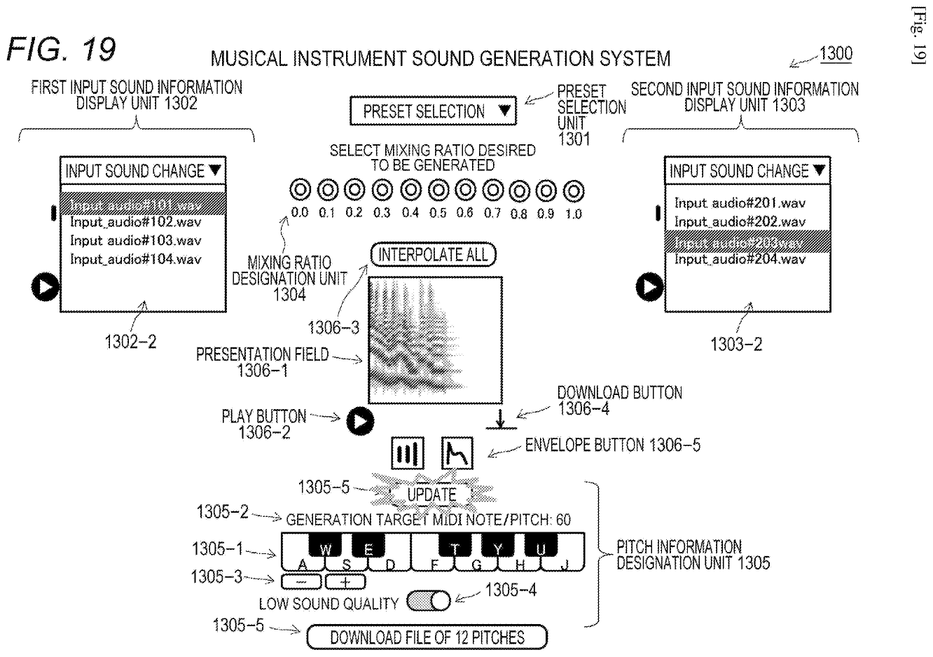

Furthermore, FIG. 19 illustrates an operation example in a case where the user generates the musical instrument sound with another pitch while maintaining the combination of the input sounds. By operating the keyboard 1305-1 and the plus/minus button 1305-3 of the pitch information designation unit 1305, the user specifies again a pitch of a musical instrument sound that is desired to be newly generated with the same combination of input sounds, and then selects the update button 1305-1 at substantially the center above the keyboard 1305-1 to instruct regeneration of the same musical instrument sound with another pitch.

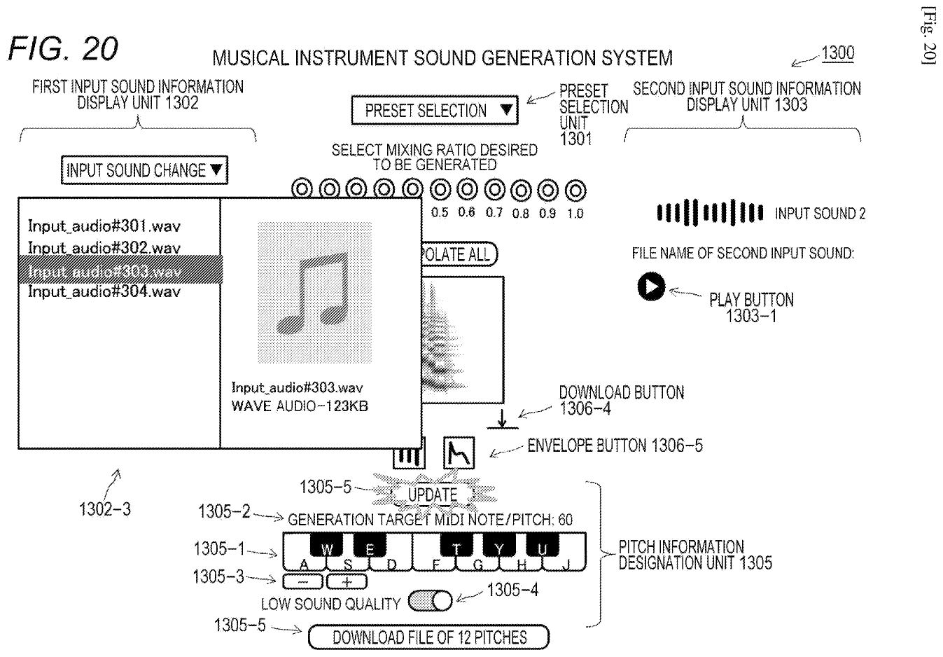

Note that FIG. 18 illustrates an operation example in which the input sound is designated or changed through the pull-down menus of the first input sound information display unit 1302 and the second input sound information display unit 1303. A list of file names of preset way format files is displayed on the pull-down menu. On the other hand, although not preset, a sound source at hand of the user can be selected as the input sound. FIG. 20 illustrates an operation example in a case where the sound source at hand of the user is designated as the first input sound. The “sound source at hand of the user” mentioned here is a way format file that can be acquired from a local disk of the client 1102 (alternatively, the information processing apparatus) or from an external accumulation device via a network. Since the musical instrument sound with a pitch to be generated is a relatively short time of about one second or several seconds, the sound source is also preferably audio data of a relatively short time of about one second or several seconds. In the example illustrated in FIG. 20, an input box 1302-3 for selecting a sound source at hand of the user appears in the first input sound information display unit 1302. The input box 1302-3 displays a list of sound sources (way format files) at hand of the user in the left half, and displays attribute information of the currently selected sound source (highlighted file) in the right half. The user can search for a sound source at hand using the left half of the input box 1302-3 and check whether or not the input sound is a desired input sound on the basis of the attribute information and the reproduction sound displayed on the right half. Then, when the selection of any way format file is confirmed on the input box 1302-3, the input box 1302-3 disappears, and the file name of the way format file whose selection is confirmed is displayed on the first input sound information display unit 1302 (not illustrated).

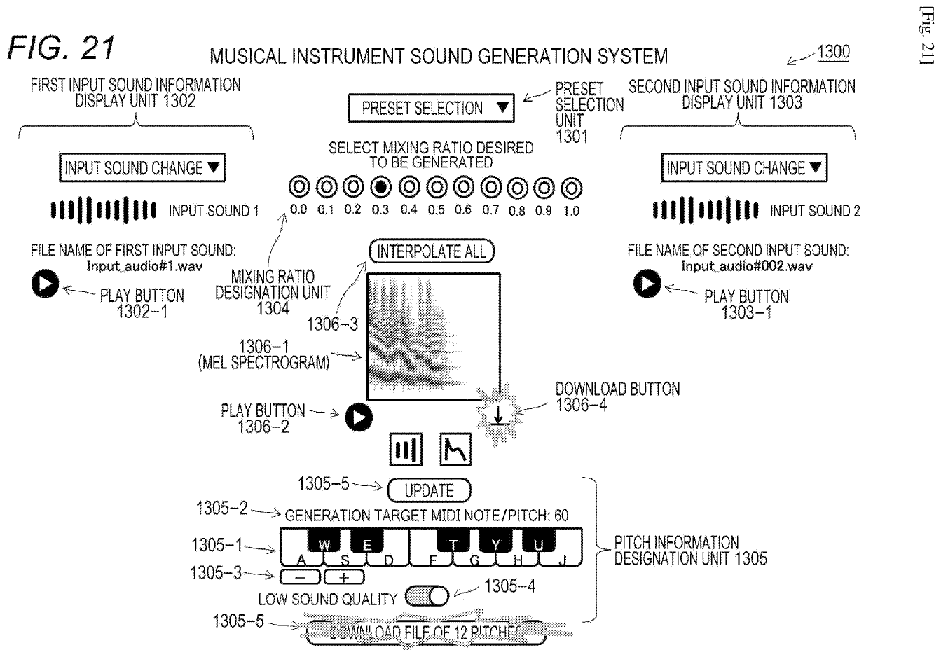

In a case where the user likes the musical instrument sound with a pitch generated on the server 1101 side, the user can download a way format file as a sound source to the client 1102 (for example, the user's own information terminal). FIG. 21 illustrates an operation example when the musical instrument sound with a pitch generated on the server 1101 side is downloaded. In the presentation field 1306-1 of the generated musical instrument sound information presentation unit 1306, a mel spectrogram of the musical instrument sound to be downloaded is displayed. The user can instruct to download a musical instrument sound with a favorite pitch by selecting a download button 1306-4 disposed near the lower right end of the presentation field 1306-1.

Furthermore, a “download file of 12 pitches” button 1305-5 is disposed substantially at the center below the keyboard 1305-1 of the pitch information designation unit 1305. The “download file of 12 pitches” button 1305-5 is a button for instructing download of not only one specific pitch designated by a key in the keyboard 1305-1 but also the musical instrument sound for 12 pitches. When the “download file of 12 pitches” button 1305-5 is selected, the server 1101 side generates a musical instrument sound with 12 pitches and downloads the musical instrument sound to the requesting client 1102. However, it takes a processing time to generate a musical instrument sound with 12 pitches.

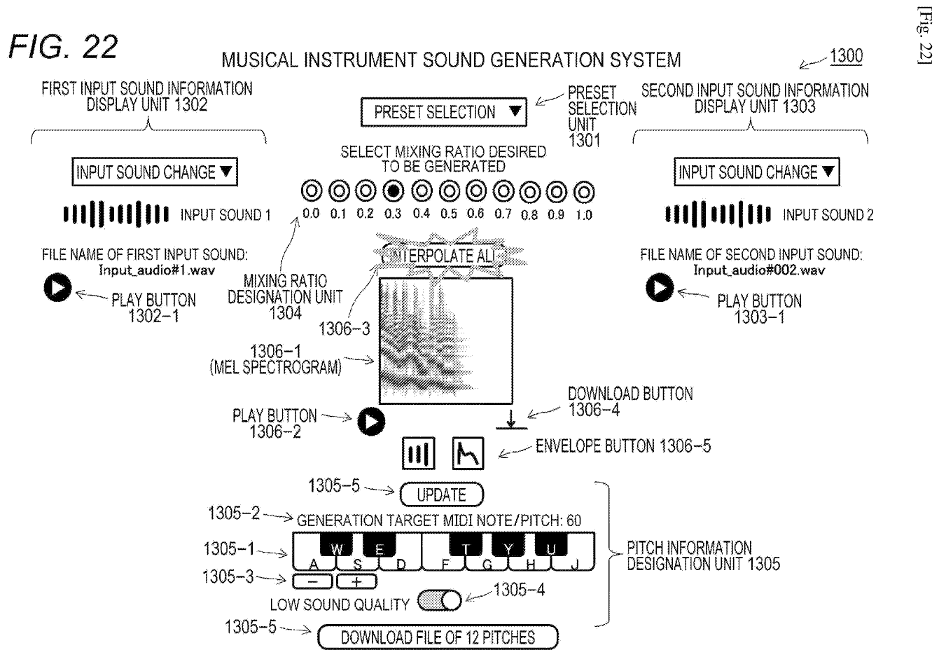

FIG. 22 illustrates a state in which the “interpolate all” button 1306-3 disposed substantially at the center above the generated musical instrument sound information presentation unit 1306 is selected. The “interpolate all” button 1306-3 is a button that instructs to combine the first input sound and the second input sound to generate the musical instrument sound with a pitch in order from the mixing ratio 0.1 to 0.9 (or from 0.0 to 1.0 inclusive of the single sound). When the “interpolate all” button 1306-3 is selected, musical instrument sounds with pitches are automatically generated in order at each mixing ratio on the server 1101 side, and the automatically generated musical instrument sounds are reproduced in order on the client 1102 side (alternatively, the automatic generation processing of the musical instrument sounds with pitches of each mixing ratio is activated in the information processing apparatus, and the musical instrument sounds sequentially generated are reproduced and output).

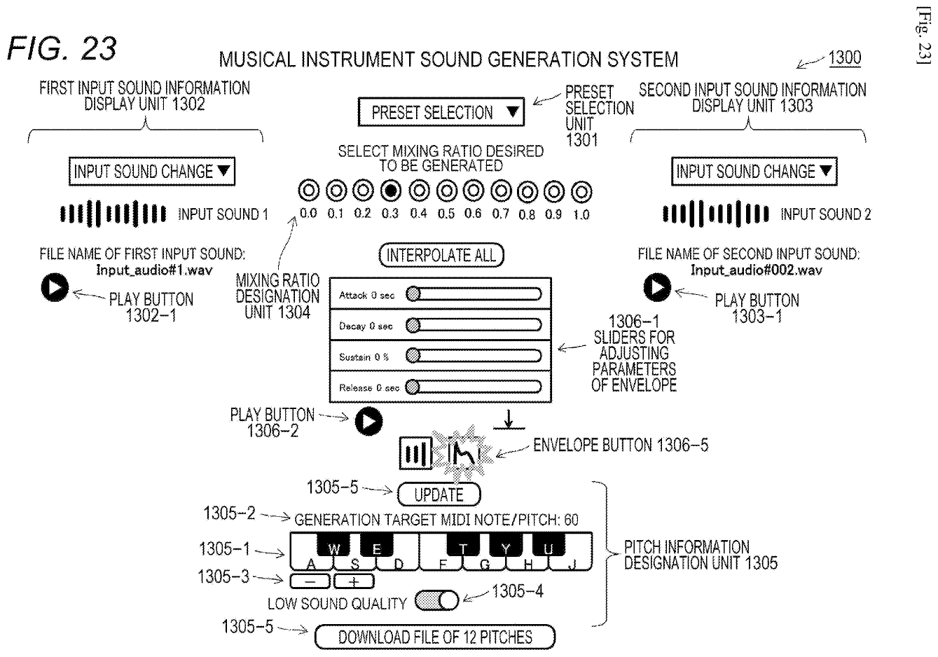

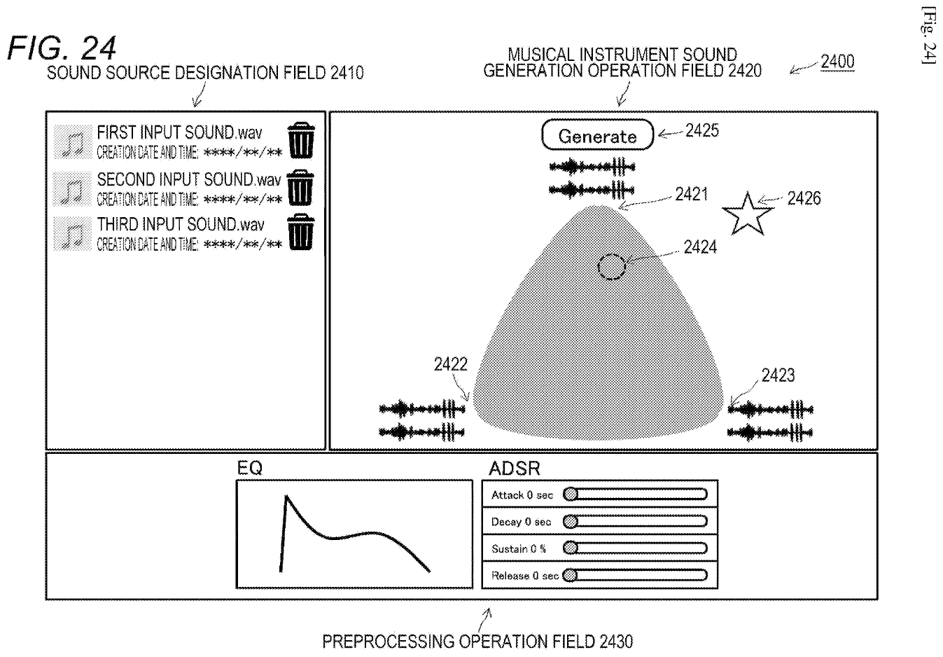

FIG. 23 illustrates an operation example in a case where envelope processing is performed. The envelope is a process of giving a typical change over time to the generated musical instrument sound. When an envelope button 1306-5 disposed substantially at the center below the generated musical instrument sound information presentation unit 1306 is selected, the presentation field 1306-1 switches from the display of the mel spectrogram to the display of a slider for adjusting each parameter of the envelope. The parameter of the envelope includes an ADSR (Attack, Decay, Sustain, Release). The shorter the Attack Time, the better the response, and the longer the Attack Time, the softer the rise. The longer the Decay Time, the decay occurs for a longer time, and the shorter the Decay Time, the decay occurs for a shorter time. Sustain Level is a parameter for controlling the volume rather than the time, and controls the volume finally reached by continuing to turn on notes. The longer the Release Time, the resonance occurs for a longer time, and the shorter the Release Time, the sound is made clearer. Note that the toggle switch 1305-4 is as described above. When the toggle switch 1305-4 is used to toggle to an off state (in other words, a state of high sound quality) of “low sound quality”, a musical instrument sound reflecting the feature of the input sound is generated with high quality and customized by an envelope or the like.

### G-2. Second Example

FIG. 24 illustrates another configuration example of a GUI screen for generating and reproducing a musical instrument sound with a pitch according to the present disclosure. However, while FIG. 13 illustrates a GUI screen used in a case where two input sounds are combined to generate a musical instrument sound, FIG. 24 illustrates a GUI screen used in a case where three input sounds are combined to generate a musical instrument sound with a pitch.

A GUI screen 2400 illustrated in FIG. 24 includes a sound source designation field 2410, a musical instrument sound generation operation field 2420, and a preprocessing operation field 2430.

The sound source designation field 2410 is an operation area for selecting each sound source of the first to third input sounds. A way format file serving as a sound source of each input sound may be selected from presets using a pull-down menu, or a sound source at hand of the user may be selected using an input box (see, for example, FIG. 20). The sound source selection operation using the pull-down menu and the input box is as described above, and a detailed description thereof will be omitted here. In the example illustrated in FIG. 24, three way format files of “First input sound.wav”, “Second input sound.wav”, and “Third input sound.wav” are selected by the user's operation, and the file name and creation date and time of each of these files are displayed in the sound source designation field 2410.

The musical instrument sound generation operation field 2420 is an operation area for performing setting when combining the first to third input sounds selected in the sound source designation field 2410. The musical instrument sound generation operation field 2420 has a triangular background. The first to third input sounds are assigned to the respective vertexes 2421 to 2423 of the triangle, and sample waveforms of the corresponding input sounds are displayed near the respective vertexes 2421 to 2423.

The preprocessing operation field 2430 is an operation area for performing preprocessing on the sample waveform of each input sound. When any of the sample waveforms of the first to third input sounds is selected in the musical instrument sound generation operation field 2420, an operation screen of an equalizer (EQ) and envelope processing (ADSR) of a sound source designated for the selected input sound is displayed in the preprocessing operation field 2430, and preprocessing of the EQ and the ADSR can be performed on the sound source.

The musical instrument sound generation operation field 2420 will be described again. When any position 2424 in the background triangle is selected, the mixing ratio of the first to third input sounds is set on the basis of the ratio of the distance between the selected position 2424 and each of the vertexes 2421 to 2423. For example, as a position closer to the vertex 2421 to which the first input sound is assigned in the triangle is selected, the mixing ratio of the first input sound becomes higher, and it is possible to request generation of a musical instrument sound that more captures a feature of the first input sound. Furthermore, when any vertex position of the triangle is selected, it means that a single sound of only the input sound assigned to the vertex among the first to third vertexes is designated, and the musical instrument sound generation can be requested from the characteristic of the single sound.

A semitransparent circle is first displayed at a position selected in the triangle. Thereafter, when the “Generate” button 2425 above the musical instrument sound generation operation field 2420 is selected, a musical instrument sound generation request is output to the server 1101 (alternatively, the process of generating the musical instrument sound is activated in the information processing apparatus). In addition, by selecting the “Generate” button 2425, the mixing ratio of the first to third input sounds designated at the position of ◯ is determined, and the display of ◯ changes from semitransparent to opaque (not illustrated).

In the GUI screen 2400 illustrated in FIG. 24, it is assumed that the musical instrument sound generation request requests generation of musical instrument sounds for 88 keys. Of course, the request may be a request for generating a musical instrument sound having 89 or more keys or 87 or less keys. Alternatively, a GUI component (for example, a keyboard) for specifying the pitch information may be disposed in the musical instrument sound generation operation field 2420 or in another field, and the request for generating a musical instrument sound with a pitch of only one key specified through the GUI component may be made.

On the server 1101 side (alternatively, in the information processing apparatus), the audio waveform of each of the input sounds of the first to third input sounds is converted into a mel spectrogram, a timbre feature amount is extracted from each mel spectrogram and mixed at a specified mixing ratio, and then a musical instrument sound with a pitch is generated with specified sound quality (either high sound quality or low sound quality) using the timbre feature amount and each pitch information of 88 keys as instance conditions. On the other hand, on the client 1102 side, the musical instrument sounds corresponding to 88 keys generated on the server 1101 side are streamed and reproduced (alternatively, it is downloaded and reproduced and output) (However, in a case where a musical instrument sound with a pitch is generated inside the information processing apparatus, the information processing apparatus reproduces and outputs the generated sound).

Note that when the parameter of any of the input sounds is changed in the preprocessing operation field 2430, the “Generate” button 2425 is highlighted, and the user is visually warned that the change in the parameter will not be reflected in the musical instrument sound unless the “Generate” button 2425 is selected to request the generation of the musical instrument sound.

The user listens to the musical instrument sounds of 88 keys generated on the server 1101 side, and if the user likes the musical instrument sounds, the user can select the favorite button 2426 and register the musical instrument sounds in the favorite list. The registration to the favorite list may include a process of recording an access method (for example, a uniform resource identifier (URI) for discriminating the location of the way format file stored on the server 1101 side, or the like) to the sound source of the corresponding musical instrument sound and a process of downloading a way format file of the musical instrument sound from the server 1101.

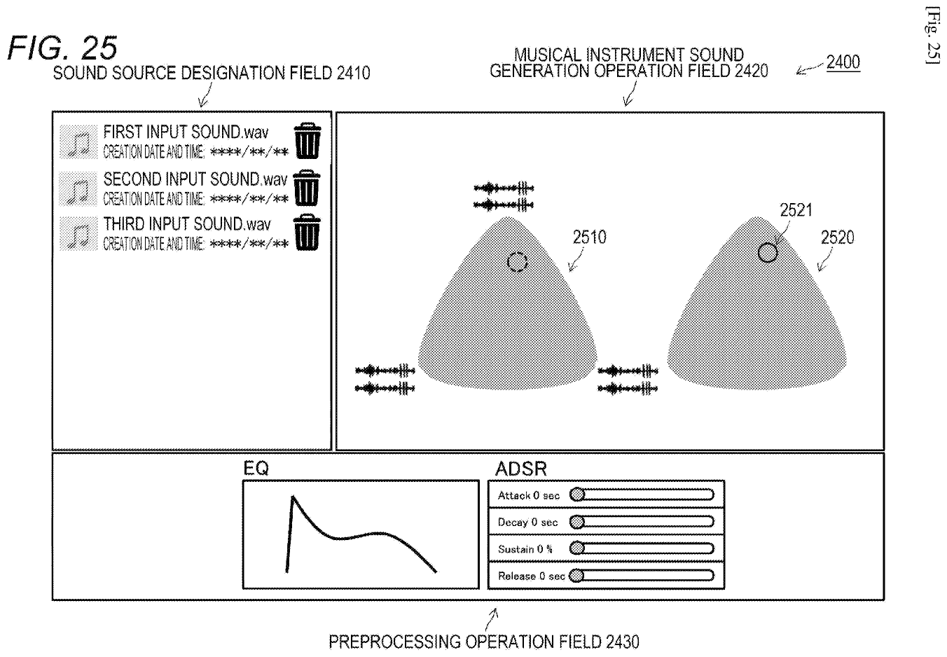

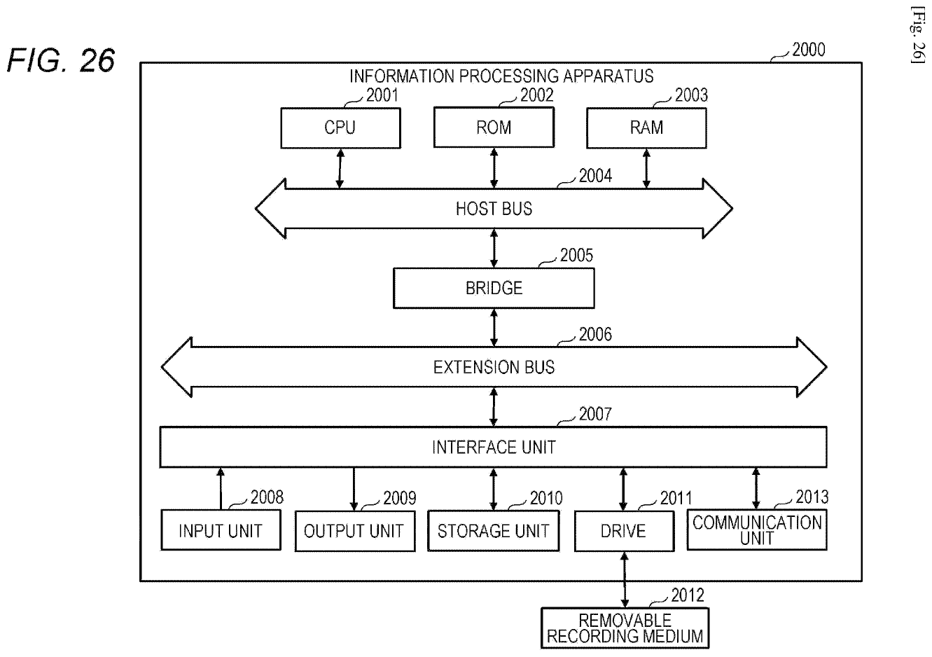

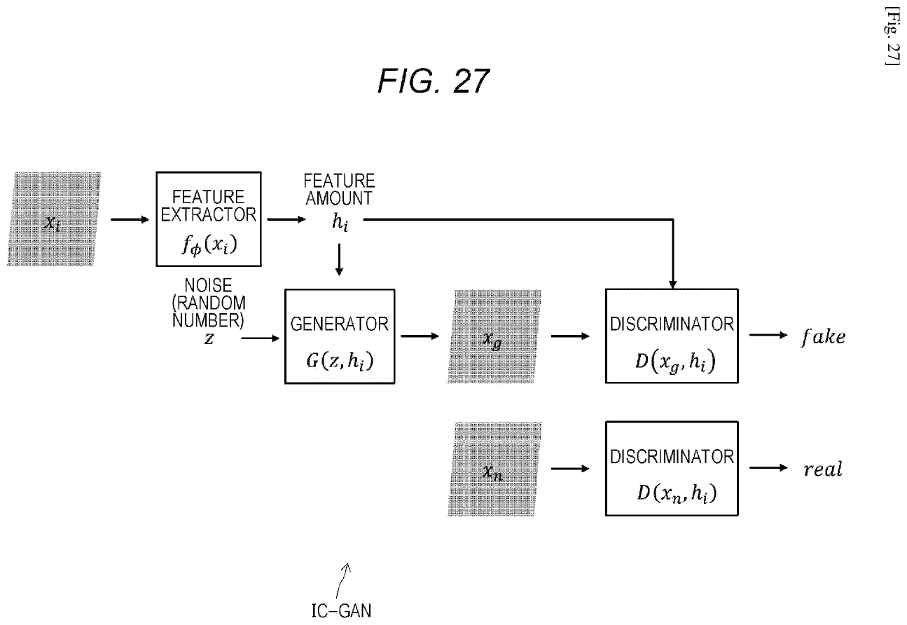

FIG. 25 illustrates a modification of the GUI screen illustrated in FIG. 24. The GUI screen 2500 illustrated in FIG. 25 is different from the GUI screen illustrated in FIG. 24 in that the musical instrument sound generation operation field 2420 has two triangles 2510 and 2520 arranged in the horizontal direction in the background.

The triangle 2510 on the left side is used to display the sample waveforms of the first to third input sounds and set the mixing ratio, similarly to the triangle in the musical instrument sound generation operation field 2420 of the GUI screen 2400 illustrated in FIG. 24. Here, detailed description of the left triangle 2510 is omitted.

On the other hand, the right triangle 2520 is used to fine tune the random number z input to the generator when generating the musical instrument sound with the instance condition using the generator generated by the present disclosure model. Also in the right triangle 2520, the first to third input sounds are assigned to the vertexes of this triangle 2520. When any position 2521 is selected in the triangle, the random number z input to the generator is finely adjusted on the basis of the ratio of the distance between the selected position 2521 and each vertex. For example, as a position closer to the vertex to which the first input sound is assigned in the triangle is selected, the random number z is finely adjusted so as to include more features of the first input sound.

### H. Configuration of Information Processing Apparatus

In this Section H, a specific configuration of an information processing apparatus provided for implementation of the present disclosure will be described.

FIG. 26 illustrates a specific hardware configuration example of an information processing apparatus 2000. The information processing apparatus 2000 illustrated in FIG. 26 includes, for example, a PC or the like. The information processing apparatus 2000 can operate as the musical instrument sound generation system 300 illustrated in FIG. 3 or can operate as the server 1101 or the client 1102 illustrated in FIG. 11.

The information processing apparatus 2000 illustrated in FIG. 26 includes a CPU 2001, a read only memory (ROM) 2002, a random access memory (RAM) 2003, a host bus 2004, a bridge 2005, an extension bus 2006, an interface unit 2007, an input unit 2008, an output unit 2009, a storage unit 2010, a drive 2011, and a communication unit 2013.

The CPU 2001 functions as an arithmetic processing device and a control device, and controls overall operation of the information processing apparatus 2000 according to various programs. The ROM 2002 stores programs (a basic input/output system, etc.) and calculation parameters used by the CPU 2001 in a nonvolatile manner. The RAM 2003 is used to load a program used in the execution of the CPU 2001 and temporarily store parameters such as work data that appropriately changes in the program execution. The program loaded into the RAM 2003 and executed by the CPU 2001 is, for example, various application programs, an operating system (OS), or the like.

The CPU 2001, the ROM 2002, and the RAM 2003 are mutually connected by a host bus 2004 including a CPU bus and the like. Then, the CPU 2001 can implement various functions and services by executing various application programs under the execution environment provided by the OS by the cooperative operation of the ROM 2002 and the RAM 2003. In a case where the information processing apparatus 2000 is a PC, the OS is, for example, Windows of Microsoft Corporation or Unix. In addition, the application program includes an application that performs processing as each of the waveform spectrogram transform unit 301, the timbre feature extraction unit 302, the generation unit 303, and the spectrogram waveform inverse transform unit 304, an application that performs learning processing of a machine learning model (DNN, etc.) used in each of the timbre feature extraction unit 302 and the generation unit 303, and an application that processes a user operation through a GUI screen as illustrated in FIGS. 13 to 25.

The host bus 2004 is connected to the extension bus 2006 via the bridge 2005. The extension bus 2006 is, for example, a peripheral component interconnect (PCI) bus or PCI Express, and the bridge 2005 is based on the PCI standard. However, it is not necessary for the information processing apparatus 2000 to have a configuration in which circuit components are separated by the host bus 2004, the bridge 2005, and the extension bus 2006, and implementation in which almost all circuit components are interconnected by a single bus (not illustrated) may be adopted.

The interface unit 2007 connects peripheral devices such as the input unit 2008, the output unit 2009, the storage unit 2010, the drive 2011, and the communication unit 2013 according to the standard of the extension bus 2006. However, not all the peripheral devices illustrated in FIG. 26 are essential, and the information processing apparatus 2000 may further include a peripheral device (not illustrated). Furthermore, the peripheral device may be built in the main body of the information processing apparatus 2000, or some peripheral devices may be externally connected to the main body of the information processing apparatus 2000.

The input unit 2008 includes an input control circuit that generates an input signal on the basis of an input from the user and outputs the input signal to the CPU 2001, and the like. The input unit 2008 may include an input device such as a keyboard, a mouse, a touch panel, or a microphone. The output unit 2009 includes, for example, a display device such as a liquid crystal display (LCD) device, an organic electroluminescence (EL) display device, and a light emitting diode (LED). A GUI operation is performed using at least a part of the devices of the input unit 2008 and the output unit 2009 to designate an input sound and a pitch and instruct generation of a musical instrument sound with a pitch, or instruct reproduction, download, or the like of the generated musical instrument sound with a pitch.

The storage unit 2010 includes, for example, a mass storage device such as a solid state drive (SSD) or a hard disk drive (HDD), but may include an external storage device. The storage unit 2010 stores files such as programs (Application, OS, etc.) executed by the CPU 2001 and various data. In addition, the storage unit 2010 is used to accumulate a way format file of an audio waveform serving as a sound source of the musical instrument sound and to store MIDI data of the generated musical instrument sound.

The removable recording medium 2012 is a cartridge type storage medium such as a microSD card. The drive 2011 performs read and write operations on the loaded removable recording medium 2012. The drive 2011 outputs data read from the removable recording medium 2012 to the RAM 2003 and the storage unit 2010, and writes data on the RAM 2003 and the storage unit 2010 to the removable recording medium 2012. The removable recording medium 2012 is used for reading a way format file of an audio waveform serving as a sound source of the musical instrument sound, and for storing MIDI data of the generated musical instrument sound.

The communication unit 2013 is a device that performs wireless communication such as Wi-Fi (registered trademark), Bluetooth (registered trademark), or a cellular communication network such as 4G or 5G. In a case where the information processing apparatus 2000 operates as the server 1101, mutual communication between the clients 1102 is performed via the communication unit 2013. Furthermore, the communication unit 2013 may include a terminal such as a universal serial bus (USB) or a high-definition multimedia interface (HDMI (registered trademark)), and may further include a function of performing data communication with a USB device such as a scanner or a printer, a display, or the like.

The series of processing described in the present specification can be executed by hardware, software, or a configuration in which hardware and software are combined. In a case where the processing is executed by the software, a program recorded with a processing sequence related to implementation of the present disclosure is installed and executed in a memory incorporated in dedicated hardware in a computer. It is also possible to install a program in a general-purpose computer capable of executing various types of processing and cause the computer to execute processing related to implementation of the present disclosure.

The program can be stored in advance in a recording medium provided in a computer such as an HDD, an SSD, or a ROM as a recording medium. Alternatively, the program may be temporarily or permanently stored in a removable recording medium such as a flexible disk, a compact disc read only memory (CD-ROM), a magneto optical (MO) disk, a digital versatile disc (DVD), a Blu-ray Disc (BD) (registered trademark), a magnetic disk, a universal serial bus (USB) memory, and the like. By using such a removable recording medium, it is possible to provide a program related to implementation of the present disclosure as so-called package software.

In addition, the program may be transferred from a download site to a computer via a network such as a wide area network (WAN) represented by a cellular network, a local area network (LAN), or the Internet in a wireless or wired manner. In the computer, the program thus transferred can be received and installed in a mass storage device such as an HDD or an SSD in the computer.

### I. Comparison with Related Studies

This Section I describes a comparison of the present disclosure with other studies on the production of musical instrument sounds.

NSynth (see NPL 2) generates a waveform of a musical instrument sound using a Wavenet (see NPL 3)-based auto encoder, but there is a problem that the generation is slow due to autoregressive sampling, and an artifact is likely to occur in the generated sound. On the other hand, the present disclosure can generate a musical instrument sound reflecting an input sound within an interactive time.

GANSynth (see NPL 4) can improve generation speed and sound quality by generating a spectrogram including phase information using an image generation model, but since GANSynth is a generation model without conditions and does not accept an input, it is difficult to search for a desired timbre in a complicated latent space. On the other hand, since the present disclosure is a generation model with an instance condition, it is possible to receive an input sound and search for a timbre reflecting the input sound in a complicated latent space.

### INDUSTRIAL APPLICABILITY

The present disclosure is heretofore described in detail with reference to the specific embodiment. However, the present disclosure should not be construed as being limited to the above-described embodiments, and it is obvious that those skilled in the art can make modifications and substitutions of the embodiments without departing from the gist of the present disclosure. Furthermore, the effects described in the present specification are merely examples, and the effects brought by the present disclosure are not limited, and there may be additional effects that are not described in the present specification.

The present disclosure can be applied to, for example, a personal computer, an electronic musical instrument, or the like that performs processing related to music production such as composition or music editing, and can generate a unique musical instrument sound from arbitrary sound inspiration to freely customize the musical instrument or assign meaning to the music by sound.

In short, the present disclosure is heretofore described in a form of an example and the content described in this specification should not be interpreted in a limited manner. In order to determine the gist of the present disclosure, the claims should be taken into consideration.

Note that the present disclosure can have the following configurations.

(1) An information processing system comprising:
circuitry configured to
   receive input sound and pitch information;
   extract a timbre feature amount from the input sound; and
   generate information of a musical instrument sound with a pitch based on the timbre feature amount and the pitch information.

(2) The information processing system of (1), wherein
the circuitry is configured to use a learned model to generate the information of the musical instrument sound.

(3) The information processing system of any of (1) to (2), wherein
the circuitry is configured to use a learned model to generate the information of the musical instrument sound with information generated by preprocessing of the input sound and the pitch information as instance conditions.

(4) The information processing system of any of (1) to (3), wherein
the circuitry is configured to extract the timbre feature amount so that no pitch information remains.

(5) The information processing system of any of (1) to (4), wherein
the circuitry is configured to extract the timbre feature using a timbre feature extractor that has performed adversarial learning regarding a pitch.

(6) The information processing system of any of (1) to (5), wherein, the circuitry is configured to:
convert the input sound into a mel spectrogram; and
   extract the timbre feature amount of an input sound based on from a mel spectrogram of the input sound.

(7) The information processing system of (6), wherein the circuitry is configured to:
generate a mel spectrogram of a musical instrument sound with a pitch using the timbre feature amount and pitch information, and construct an audio waveform based on the mel spectrogram.

(8) The information processing system of (7), wherein the circuitry is configured to:
convert the mel spectrogram into a frequency scale in a linear spectrogram;
restore a phase of the linear spectrogram; and
perform a Fourier inverse transform on the linear spectrogram after restoring the phase of the linear spectrogram.

(9) The information processing apparatus of (8), wherein the circuitry is configured to:
set a solution corrected to a non-negative value to a solution of a least squares method without a non-negative value as an initial value of iterative calculation; and
   perform frequency scale conversion according to an iterative method of repeating update according to a gradient method and correction to a non-negative value.

(10) The information processing system of any of (1) to (9), wherein the circuitry is configured to:
receive an input of a plurality of input sounds;
extract a timbre feature amount from each input sounds; and
generate musical instrument sound information based on a timbre feature amount obtained by mixing the timbre feature amounts of the plurality of input sounds and pitch information.

(11) The information processing system of (10), wherein the circuitry is configured to:
receive information regarding a mixing ratio of a plurality of input sounds; and
generate musical instrument sound information based on the timbre feature amount obtained by mixing timbre feature amounts, the mixing ratio and pitch information.

(12) The information processing system of any of (1) to (11), wherein
the circuitry is configured to receive the input sound and pitch information based on a user operation.

(13) The information processing system of any of (1) to (12), wherein
the circuitry is configured to output information of the musical instrument sound.

(14) The information processing system of any of (1) to (13), wherein
the circuitry is configured to display a user interface configured to receive a user input corresponding to the input sound and pitch information.

(15) The information processing system of (14), wherein
the user interface is configured to receive a first input corresponding to a first input sound and a second input corresponding to a second input sound, and
the user interface is configured to receive a mixing ratio corresponding to the first input sound and the second input sound.

(16) The information processing system of (15), wherein
the graphical user interface includes at least a first graphic and a second graphic, wherein
the first graphic is configured to receive the first input corresponding to the first input sound and the second input corresponding to a second input sound, and
the second graphic is configured to receive the timbre feature amount.

(17) An information processing method comprising:
receiving input sound and pitch information;
extracting a timbre feature amount from the input sound; and
generating information of a musical instrument sound with a pitch based on the timbre feature amount and pitch information.

(18) One or more non-transitory computer readable medium, which, when executed by circuitry, cause the circuitry to:
receive input sound and pitch information;
extract a timbre feature amount from the input sound; and
generate information of a musical instrument sound with a pitch based on the timbre feature amount and pitch information.

(19) A sound generation system comprising:
a terminal configured to requests generation of a musical instrument sound; and
an information processing apparatus that generates a musical instrument sound, wherein
the information terminal is configured to
   receive input sound and pitch information;
   extract a timbre feature amount from the input sound; and
   generate the information of a musical instrument sound with a pitch based on the timbre feature amount and the pitch information.

(20) An information terminal comprising:
a communication interface configured to communicate with an information processing system; and
a user interface configured to receive a designation related to generation of a musical instrument sound including an input sound and pitch information, wherein
the communication interface is configured to
   transmit a request for generating the musical instrument sound including the input sound and pitch information to the information processing system, and
   receive, from the information processing system, information of the musical instrument sound.

### REFERENCE SIGNS LIST

300 Sound generation system
301 Waveform spectrogram transform unit
302 Timbre feature extraction unit
303 Generation unit
304 Spectrogram waveform inverse transform unit
501 Timbre feature extractor
502 Musical instrument discriminator
601 Timbre feature extractor
602 Musical instrument discriminator
603 Pitch discriminator
801 Frequency scale conversion unit
802 Phase restoration unit
803 Inverse short-time Fourier transform unit (iSTFT)
901 Initialization unit
902 Update unit
903 Correction unit
1001 Initialization unit
1002 Initial value correction unit
1003 Update unit
1004 Correction unit
1100 Sound generation system (client server model)
1101 Server
1102 Client
2000 Information processing apparatus
2001 CPU
2002 ROM
2003 RAM
2004 Host bus
2005 Bridge
2006 Extension bus
2007 Interface unit
2008 Input unit
2009 Output unit
2010 Storage unit
2011 Drive
2012 Removable recording medium
2013 Communication unit

1. An information processing system comprising:
circuitry configured to
receive input sound and pitch information;
extract a timbre feature amount from the input sound; and
generate information of a musical instrument sound with a pitch based on the timbre feature amount and the pitch information.

2. The information processing system of claim 1, wherein
the circuitry is configured to use a learned model to generate the information of the musical instrument sound.

3. The information processing system of claim 1, wherein
the circuitry is configured to use a learned model to generate the information of the musical instrument sound with information generated by preprocessing of the input sound and the pitch information as instance conditions.

4. The information processing system of claim 1, wherein
the circuitry is configured to extract the timbre feature amount so that no pitch information remains.

5. The information processing system of claim 1, wherein
the circuitry is configured to extract the timbre feature using a timbre feature extractor that has performed adversarial learning regarding a pitch.

6. The information processing system of claim 1, wherein, the circuitry is configured to:
convert the input sound into a mel spectrogram; and
extract the timbre feature amount of an input sound based on from a mel spectrogram of the input sound.

7. The information processing system of claim 6, wherein the circuitry is configured to:
generate a mel spectrogram of a musical instrument sound with a pitch using the timbre feature amount and pitch information, and
construct an audio waveform based on the mel spectrogram.

8. The information processing system of claim 7, wherein the circuitry is configured to:
convert the mel spectrogram into a frequency scale in a linear spectrogram;
restore a phase of the linear spectrogram; and
perform a Fourier inverse transform on the linear spectrogram after restoring the phase of the linear spectrogram.

9. The information processing apparatus of claim 8, wherein the circuitry is configured to:
set a solution corrected to a non-negative value to a solution of a least squares method without a non-negative value as an initial value of iterative calculation; and
perform frequency scale conversion according to an iterative method of repeating update according to a gradient method and correction to a non-negative value.

10. The information processing system of claim 1, wherein the circuitry is configured to:
receive an input of a plurality of input sounds;
extract a timbre feature amount from each input sounds; and
generate musical instrument sound information based on a timbre feature amount obtained by mixing the timbre feature amounts of the plurality of input sounds and pitch information.

11. The information processing system of claim 10, wherein the circuitry is configured to:
receive information regarding a mixing ratio of a plurality of input sounds; and
generate musical instrument sound information based on the timbre feature amount obtained by mixing timbre feature amounts, the mixing ratio and pitch information.

12. The information processing system of claim 1, wherein
the circuitry is configured to receive the input sound and pitch information based on a user operation.

13. The information processing system of claim 1, wherein
the circuitry is configured to output information of the musical instrument sound.

14. The information processing system of claim 1, wherein
the circuitry is configured to display a user interface configured to receive a user input corresponding to the input sound and pitch information.

15. The information processing system of claim 14, wherein
the user interface is configured to receive a first input corresponding to a first input sound and a second input corresponding to a second input sound, and
the user interface is configured to receive a mixing ratio corresponding to the first input sound and the second input sound.

16. The information processing system of claim 15, wherein
the graphical user interface includes at least a first graphic and a second graphic, wherein
the first graphic is configured to receive the first input corresponding to the first input sound and the second input corresponding to a second input sound, and
the second graphic is configured to receive the timbre feature amount.

17. An information processing method comprising:
receiving input sound and pitch information;
extracting a timbre feature amount from the input sound; and
generating information of a musical instrument sound with a pitch based on the timbre feature amount and pitch information.

18. One or more non-transitory computer readable medium, which, when executed by circuitry, cause the circuitry to:
receive input sound and pitch information;
extract a timbre feature amount from the input sound; and
generate information of a musical instrument sound with a pitch based on the timbre feature amount and pitch information.

19. A sound generation system comprising:
a terminal configured to requests generation of a musical instrument sound; and
an information processing apparatus that generates a musical instrument sound, wherein
the information terminal is configured to
receive input sound and pitch information;
extract a timbre feature amount from the input sound; and
generate the information of a musical instrument sound with a pitch based on the timbre feature amount and the pitch information.

20. An information terminal comprising:
a communication interface configured to communicate with an information processing system; and
a user interface configured to receive a designation related to generation of a musical instrument sound including an input sound and pitch information, wherein
the communication interface is configured to
transmit a request for generating the musical instrument sound including the input sound and pitch information to the information processing system, and
receive, from the information processing system, information of the musical instrument sound.
